(19) United States
(12) Patent Application Publication
(10) Pub. No.: US 2012/0185369 A1
(43) Pub. Date: Jul. 19, 2012

(54) BALANCE GROUPS IN A GLOBAL REPORTING INFRASTRUCTURE

(75) Inventors: Ravi Bhushan Sinha, Gachibowli (IN); Stephen L. Russell, Three Bridges (AU); Maria C. Wood, Melbourne (AU)

(73) Assignee: Oracle International Corporation, Redwood Shores, CA (US)

(21) Appl. No.: 13/236,632

(22) Filed: Sep. 19, 2011

Related U.S. Application Data
(60) Provisional application No. 61/384,264, filed on Sep. 18, 2010.

(51) Int. Cl. G07C 1/10; G06Q 40/00

(52) U.S. Cl. 705/32

(57) ABSTRACT

Disclosed is a computer implemented method, the method includes selecting one or more balance types for a balance group, selecting time periods for which the balance group is to be effective, selecting a context in which the balance group is to operation is selected after selecting the one or more balance types and time periods, determining sort options are needed to support a functionality to be provided by the balance group and selecting a format type for the balance group, wherein the format type indicates the format in which defined balance information is organized when returned to a payroll application.

### CROSS-REFERENCE TO RELATED APPLICATIONS

This application claims the benefit, under 35 U.S.C. §119(e), of U.S. Provisional Patent Application No. 61/384,264, filed Sep. 18, 2010, entitled “Balance Groups and the Global Reporting Infrastructure,” and naming R. Sinha, S. Russell and M. Wood as inventors. This provisional patent application is hereby incorporated by reference herein, in its entirety.

Portions of this patent application contain materials that are subject to copyright protection. The copyright owner has no objection to the facsimile reproduction by anyone of the patent document, or the patent disclosure, as it appears in the Patent and Trademark Office file or records, but otherwise reserves all copyright rights whatsoever.

### FIELD OF INVENTION

Embodiments of the present invention relate to the field of payroll reporting, and more particularly, relates to a system and architecture that provide for balance groups in a global reporting infrastructure.

### BACKGROUND

Payroll legislative reporting for each country uses individual and diverse criteria for accumulating payroll balance values. Typically, payroll software vendors write individual country specific reports and user interfaces to define accumulators and produce reports. Payroll legislative reporting for each country uses individual and diverse criteria for accumulating payroll balance values. Typically, payroll software vendors write individual country specific reports and user interfaces to define accumulators and produce reports. As will be appreciated, the need for payroll software vendors to write individual country specific reports and user interfaces to define accumulators and produce reports complicates the creation of such payroll software, as well as the use of such payroll software by end-users.

Thus, it is desirable to simplify the reporting of payroll balances, both in the creation and use of payroll software providing such features. Further, payroll software providing such features should be designed to ensure consistency in the processing of payroll balance values, particularly when such payroll software is to operate in a global context.

### BRIEF DESCRIPTION OF THE DRAWINGS

The present invention may be better understood, and its numerous objects, features and advantages made apparent to those skilled in the art by referencing the accompanying drawings.

FIG. 1 is a block diagram illustrating an application architecture according to embodiments of the present invention.

FIG. 2 is a block diagram depicting a payroll system architecture according to embodiments of the present invention.

FIG. 3 is a flow diagram illustrating a process for constructing one or more compensation elements, according to embodiments of the present invention.

FIG. 4 is a block diagram illustrating a payroll application architecture according to embodiments of the present invention.

FIG. 5 is a block diagram illustrating an example of a data model according to the present invention.

FIG. 6A is a flow diagram illustrating an example of the operations performed in a payroll application architecture according to the embodiment of the present invention.

FIG. 6B is a flow diagram illustrating an example of the operations that can be performed in satisfying a request directed to balance invalidation, according to the embodiment of the present invention.

FIG. 6C is a flow diagram depicting an example of the operations performed by a metadata layer entity employing balance group concepts according to embodiments of the present invention.

FIG. 7 is a flow diagram illustrating an example of the operations by a metadata layer entity, according to embodiments of the present invention.

FIG. 8 is a flow diagram illustrating an example of a process of creating a balance group, according to embodiments of the present invention.

FIG. 9 is a flow diagram illustrating an example of a process for editing an existing balance group, according to embodiments of the present invention.

FIG. 10 is a flow diagram illustrating an example of a delete balance group operation, according to embodiments of the present invention.

FIG. 11 depicts a block diagram of a computer system suitable for implementing various aspects of embodiments of the present invention.

FIG. 12 is a block diagram depicting a network architecture suitable for implementing various aspects of embodiments of the present invention.

### DETAILED DESCRIPTION

### Introduction

Embodiments of the present invention provide for a generic reporting infrastructure, referred to herein as a balance group. The implementation and use of balance groups simplifies reporting of payroll balances and ensures consistency in a global context. This feature ties groups of balances into global collections, and makes it easier and faster to build user interfaces and reports at a global level that meet the specific legislative reporting requirements of many countries. This feature further significantly reduces time and cost of development for an important legislative support component of payroll systems and makes it easier and faster to develop new local payroll solutions on a global engine.

Balance group functionality provides greater flexibility and consistency for including balance values in reports and user interfaces. The use of balance groups addresses issues facing global payroll, localization and end-users, providing the ability to select and sequence a group of balances. This grouping of balances can then be used in any number of reports/user interfaces and processes. In certain implementations, the use of balance groups replaces the use of balance attributes to be displayed to end-users. Group balance processing is handled through balance groups.

Both the extend balance group functions and alternate balance group functions are described herein, and as such, support balance group extension capability. The balance group functionality provides greater flexibility and consistency for including balance values in reports and user interfaces. Balance groups provide core payroll, localization teams and end-users the ability to select and sequence a group of balances. This grouping of balances can then be used in any number of reports/user interfaces and processes.

Balance groups can be predefined and delivered as part of the global pay product. Localization teams may also create country specific balance groups for use with localized reports and user interfaces. However, balance groups are also able to be defined by end-users. This provides end-users more flexibility with viewing balances for predefined reports and user interfaces as well as customized reports and user interfaces.

### Example Implementation Providing Balance Group Functionality

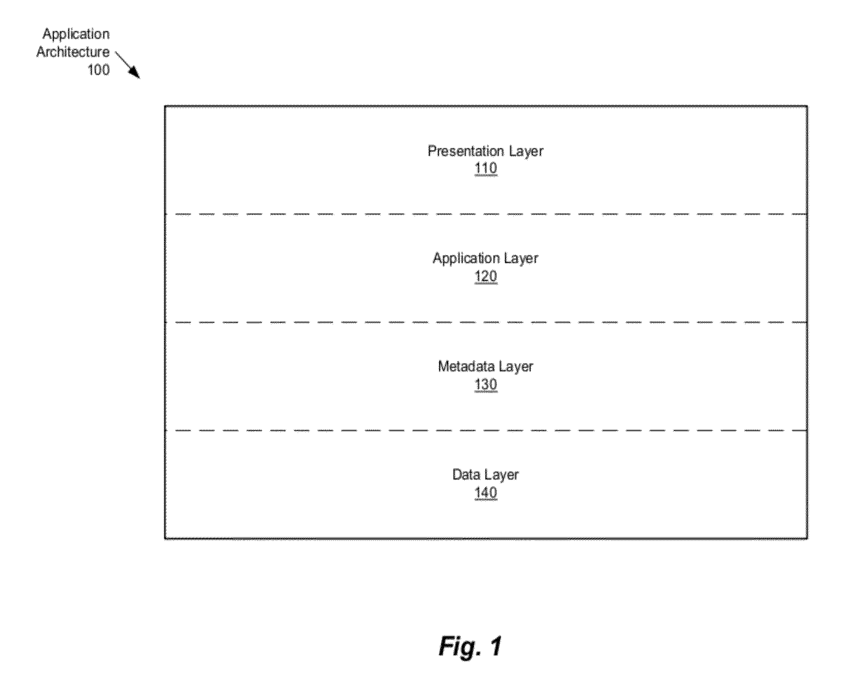

FIG. 1 is a block diagram illustrating an application architecture 100 according to embodiments of the present invention. As is illustrated, application architecture 100 includes a presentation layer 110, an application layer 120, a metadata layer 110 and a data layer 120. In the alternative, application architectures such as application architecture 100 are sometimes divided into three layers, a views layer (corresponding to presentation layer 110), a logical layer (corresponding to application layer 120 and metadata layer 110), and a physical layer (corresponding to data layer 120).

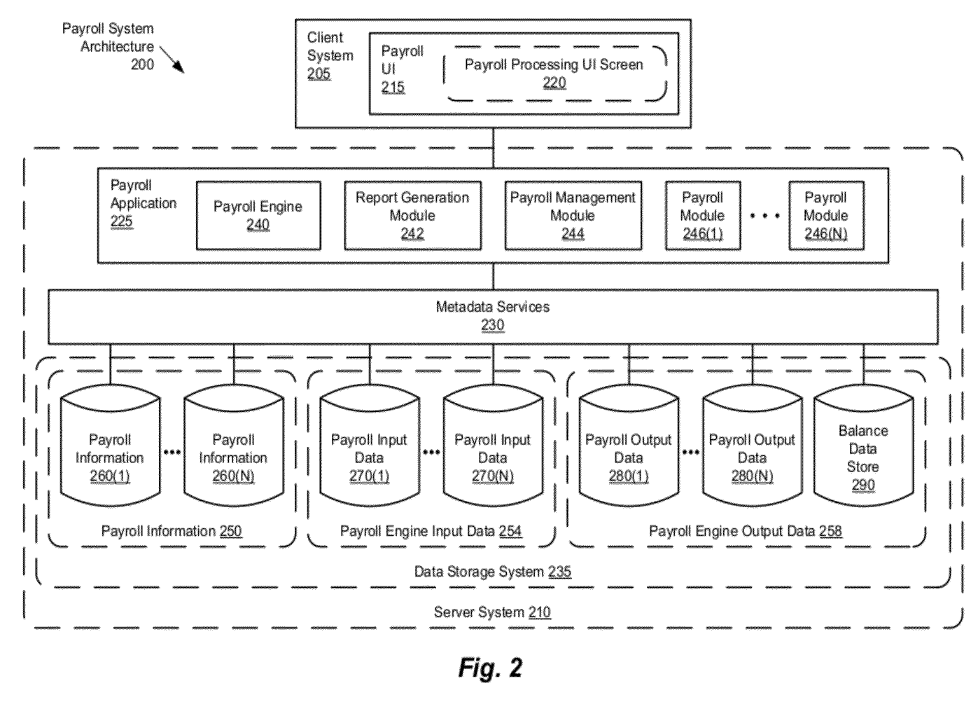

FIG. 2 is a block diagram depicting a payroll system architecture 200 according to embodiments of the present invention. As depicted in FIG. 2, payroll system architecture 200 is architected as a client server system, and so is depicted as including a client system 205 and a server system 210. In light of the fact that the primary purpose of payroll system architecture 200 is to process and maintain payroll information, client system 205 is depicted as presenting a payroll user interface (UI) 215, in which is presented a payroll processing UI screen 220. Server system 210 also provides features, functionalities and elements in support of the payroll processing activities to which payroll system architecture 200 is directed. Thus, server system 210 is depicted as including a payroll application 225, metadata services 230 and a data storage system 235. As will be appreciated in reference to application architecture 100 of FIG. 1, payroll system architecture 200 is designed in a manner that reflects the architecture of application architecture 100, and so includes elements at the presentation layer (e.g., payroll UI 215), at the application layer (e.g., payroll application 225), a metadata layer (e.g., metadata services 230), and a data layer (e.g., data storage system 235).

In support of the payroll processing responsibilities of payroll system architecture 200, payroll application 225 includes a variety of modules, which allow payroll application 225 to provide the desired functionality to end-users of client system 205. Payroll application 225 is depicted in FIG. 2 as including a payroll engine 240, a report generation module 242, a payroll management module 244, and various other modules (depicted in FIG. 2 as payroll modules 246(1)-(N)). The various modules of payroll application 225 allow an end-user accessing payroll application 225 (via payroll UI 215) to perform various tasks related to the processing and maintenance of payroll information. For example, payroll engine 240 provides functionality related to the calculations performed in determining an employee's wages, taxes, and the like. Report generation module 242 provides functionality that facilitates the generation of information based on the payroll information processed and maintained in payroll system architecture 200. Payroll management module 244 facilitates the maintenance of payroll information, as well as the various functionalities used to process that payroll information.

Payroll application 225 accesses the data stored in data storage system 235 via metadata services 230. Metadata services 230 provide an abstraction layer between payroll application 225 and the data sources within data storage system 235, thereby abstracting such data sources and simplifying the interactions therewith.

As depicted in FIG. 2, data storage system 235 includes a variety of data sources. Among these data sources are payroll information 250, payroll engine input data 254 and payroll engine output data 258. As will be appreciated, in light of the present disclosure, the data sources depicted in FIG. 2 (and throughout the figures) are merely examples of the wide variety of data sources that might be included in the architectures depicted herein. Moreover, the structure of such data sources depicted in FIG. 2 and other figures presented herein are also presented merely as examples. Thus, for example, the data and information maintained in payroll information 250, payroll engine input data 254, and payroll engine output data 258 could easily be combined into a single data store.

As depicted in FIG. 2, payroll information 250 includes a number of data sources (identified in FIG. 2 as payroll information 260(1)(N)). In a similar fashion, payroll engine input data 254 also includes a number of data sources (identified in FIG. 2 as payroll input data 270(1)-(N)). As will be appreciated, payroll input data 270(1)-(N)) is accessed by payroll application 225 to be used as inputs for its modules (e.g., payroll engine 240). As depicted in FIG. 2, payroll engine output data 258 also is shown as including a number of data sources (identified in FIG. 2 as payroll output data 280(1)-(N)), which can be understood as storing output data from one or more of the modules of payroll application 225 (e.g., payroll engine 240). As can also be seen in FIG. 2, payroll engine output data 258 further includes a balance data store 290. While such data sources might not otherwise be separate from other data sources (whether depicted in a figure, or in actuality), they are depicted as being separate in data storage system 235 merely for the sake of clarity. Balance data store 290 maintains data for the defined balances used and maintained by the modules of payroll application 225, as well as other information regarding those defined balances.

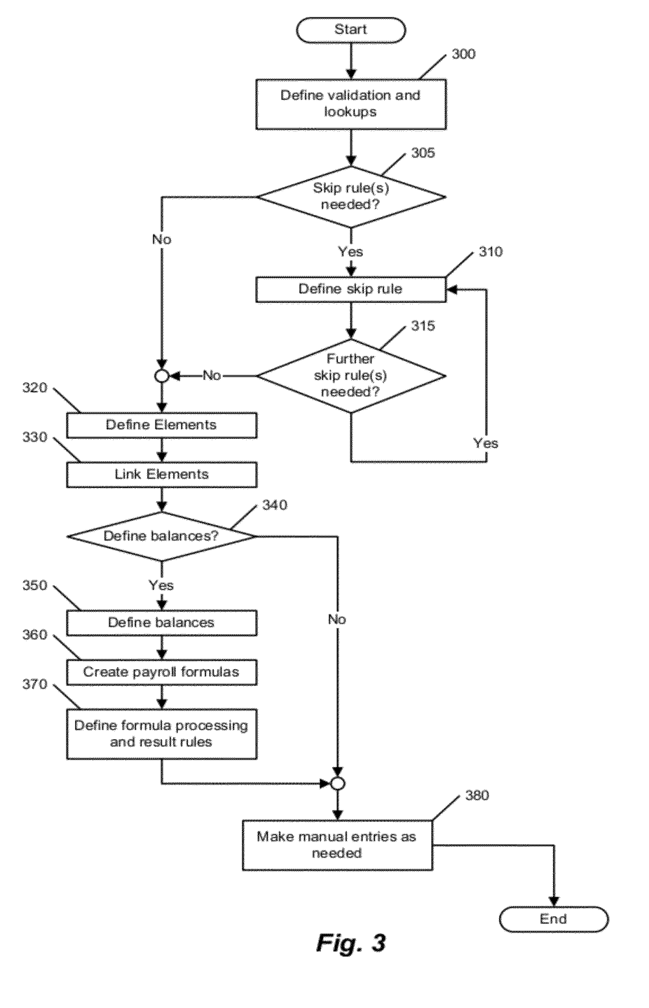

FIG. 3 is a flow diagram illustrating a process for constructing one or more compensation elements, according to embodiments of the present invention. In preparation for performing payroll calculations, one or more compensation elements may need to be constructed. In constructing such compensation elements, earnings, deductions, and other items in a given compensation package typically need to be defined. As will be appreciated, in addition to the basic items of a given compensation package, other items may need to be configured, an include alternative compensation types, as well as benefits. More specifically, these includes salaries, absence and PTO accrual, standard and advanced benefits, collective agreements and the like. The process in FIG. 3 provides for the definition of payroll elements, which allow an end-user to define or select to control the entry and processing of earnings, deductions, benefits, other payments, and the like.

The element definition process depicted in FIG. 3 begins with the definition of validation and lookups (step 300). In so doing, validation parameters for entries of any new elements being created are defined. By defining lookups, compensation entries can be restricted to a list of valid values. Further, validation can be performed on compensation entries using formulas, which can be created as a type of element input validation. Further still, more complicated validation criteria can be employed, for example, by creating a matrix of values for use in the formulas. Next, a determination is made as to whether one or more skip rules are needed (step 305). If one or more skip rules are necessary, a given skip rule is defined (step 310). If further skip rules are needed (step 315), definitions for those further skip rules are defined (step 310). The definition of element skip rules provide for situations in which one or more element in a given template is not to be processed in every payroll run. Such skip rules allow for the creation of formulas to define the conditions in which a given element should or should not be processed during a given payroll run.

Next, the process depicted in FIG. 3 proceeds to the definition of one or more payroll element for the template being configured (step 320). At this point in the process, elements and their input values are typically defined, which can include recording information regarding an employee's compensation, benefits, and other such information. This may include the definition or certain earnings and deductions for processing, though legislative deductions are typically predefined. At this point, frequency rules can also be defined, if necessary, to determine the periods in which a given element should be processed. Next, links are created for predefined and user-defined elements (step 330). Such links (also referred to herein as element links) identify one or more groups of employees who are eligible to receive an element of the payroll.

A determination is then made as to whether one or more defined balances are needed in the given template (step 340). As part of creating defined balances (step 350), any new balance dimensions that may be needed as a result can be created, as well. At this point, secondary element classification can be defined, and classes of balanced feeds created by entering or removing secondary classifications from the existing elements. Further in this regard, user balances can be defined and balance feeds created for individual elements. Once the aforementioned definition and creation operations are performed, initial values for balances can be uploaded, to set initial values. Once the defined balances have been created, payroll formulas can be written for processing legislative deductions and other such items (step 360). Next formula processing and result rules are defined (step 370). Processing rules can be defined for a given element in order to indicate which formula or formulas process a given element. Similarly, one or more formula result rules can be defined, in order to specify the handling of such formulas results.

Once the desired defined balances have been created and/or configured, or if no such defined balances are needed (step 340), manual entries can then be made, as needed (step 380). In so doing, entries of one or more elements for those who should receive such entries are made, in the case in which a given payroll element is without standard links. Payroll balances show the positive or negative accumulation of particular values over periods of time, and are fed either by the direct run results (that is, pay values) of elements processed in the payroll run, or by input values. Balance dimensions and levels are characteristics of balances. Balances exist for various time dimensions, such as current run, period-to-date, month, quarter-to-date, and year-to-date. Balances also exist at different levels, such as assignment level or person level. Balances for individual employee assignments are at the assignment level. If an employee holds more than one assignment at the same time, the end-user can hold balances at the person level. For example, a person level gross earnings balance is the sum of an employee's assignment level gross earnings balances.

The selection of compensation elements to feed a balance can be accomplished in several ways, including, for example:
Select a primary classification. The run results of all elements in the classification feed the balance.
Select a secondary classification. Again, it is the run results of the elements that feed the balance.
Select an individual element.

Any number of classifications or elements can be selected to feed a balance. However, a mixture of classifications and individual elements should not be used to feed a balance. When an element or classification is selected as a balance feed, the end-user specifies whether the run results (or input values) should be added to or subtracted from the balance. Balances and balance feeds can be pre-defined for existing elements. Additional balances can also be defined. Further, secondary element classifications can also be defined to create subsets within primary classifications. Balance feeds can be created by selecting balances to be fed by the input values of an element. Balances are either fed by whole classifications of elements or by individual elements, but not by both. An element can used to feed as many balances as need be. Additionally, an element can be classified using secondary classifications. These determine the balances that the element feeds. The end-user can query a balance in the balance window and choose the classifications button to view the list of classifications that feed that balance.

Defining a balance includes defining its feeds and dimensions. When selecting feeds for the balance, an end-user can choose between specifying element input values directly, or selecting element classifications to determine the feeds. Both methods should not be chosen together. Balances often share a common relevancy to certain assignments. In some localizations, base balances can be defined to imply a relationship between the balances that can be relied upon when processing and reporting.

Further, earnings and deductions can be selected from a template library for a given country and industry. The earnings and deductions selected form a template set that can be loaded into a business group. The template set includes the elements and the balances, balance feeds, and formulas required for payroll processing. Any of these definitions can be configured to match the requirements at hand.

In certain legislations, an end-user can initiate earnings and deductions, and generate the required elements, along with balances, balance feeds, and formulas. The method of initiating earnings and deductions depends on the given localization. Typically, an element design wizard, earnings and deductions window, or other template window can be used for specific earnings and deduction types. The processing options selected in the wizard or window determine the rules embedded in the generated elements and formulas. As with template elements, the end-user can configure generated elements and formulas to match any special requirements.

Elements are grouped into primary classifications, such as earnings and voluntary deductions. In a human resources department, the primary classifications can be used to identify groups of elements for information and analysis purposes. In a payroll department, the classifications control processing, including the sequence in which elements are processed and the balances they feed. These primary classifications and some balances are provided for the end-user, mainly to reflect tax legislation, and are designed to meet the legislative requirements of the given country. Additional balances can created, and can be fed by any of the primary classifications.

Secondary classifications can be defined to feed user-defined balances. These secondary classifications are subsets of the primary classifications. In the legislation of some jurisdictions, secondary classifications can be predefined. As with primary classifications, predefined secondary classifications cannot be changed or removed, and the predefined balance feeds created for them cannot be disabled. Input values can be used to define the input values for the element. Depending on the type of element defined, one or more default input values may be applied

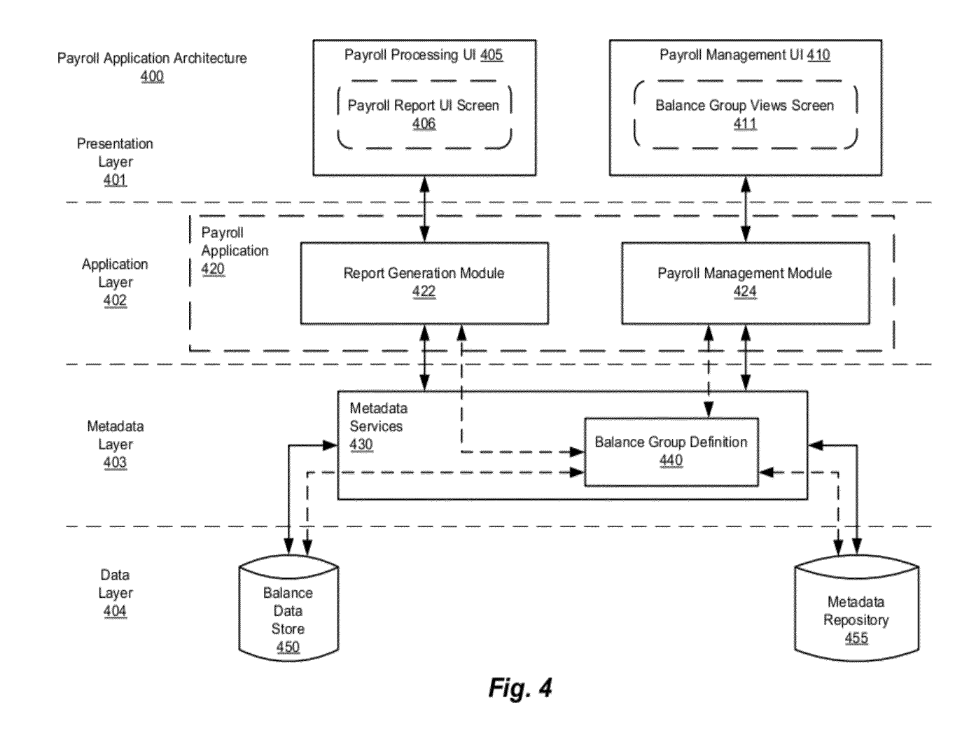

FIG. 4 is a block diagram illustrating a payroll application architecture 400, according to embodiments of the present invention. While the block diagram of FIG. 4 illustrates examples only of the conceptual entities extant within payroll application architecture 400, the similarities between payroll application architecture 400 and, for example, payroll architecture system 200, as well as application architecture 100, will be apparent to one of skill in the art, in light of the present disclosure. In the manner of those aforementioned architectures, payroll application architecture 400 includes a presentation layer 401, an application layer 402, a metadata layer 403, and a data layer 404. At presentation layer 401, the various user interfaces with which an end-user interacts in processing payroll information are shown. Such user interfaces, as depicted, include a payroll processing UI 405 (which, in turn, presents a payroll report UI screen 406), and a payroll management UI 410 (which, in turn, presents a balance group views screen 411). As will be appreciated, while payroll processing UI 405 and payroll management 410 (and their respective screens) are shown as being separate (at least from a conceptual standpoint), such divisions are merely for clarity, and the functionality of each can exist in a single user interface.

Application layer 402 is depicted in FIG. 4 as including a payroll application 420. Payroll application 420, as will be appreciated, is comparable to payroll application 225 of FIG. 2. That being the case, payroll application 420 is depicted in FIG. 4 as including a report generation module 422 (not unlike report generation module 242 of FIG. 2) and a payroll management module 424 (again, not unlike payroll management module 244 of FIG. 2).

Unlike the depiction of metadata services 230 in FIG. 2, however, metadata services 430 in metadata layer 403 is shown as maintaining a balance group definition 440. As can be seen, balance group definition 440 is accessed, used and managed by a variety of elements within payroll application architecture 400 with which metadata services 430 interacts. In addition to interacting payroll application 420 and its various modules (e.g., report generation module 422 and payroll management module 424), metadata services 430 provides access to a balance data store 450. It will be appreciated that balance data store 450 and balance data store 290 are comparable to one another.

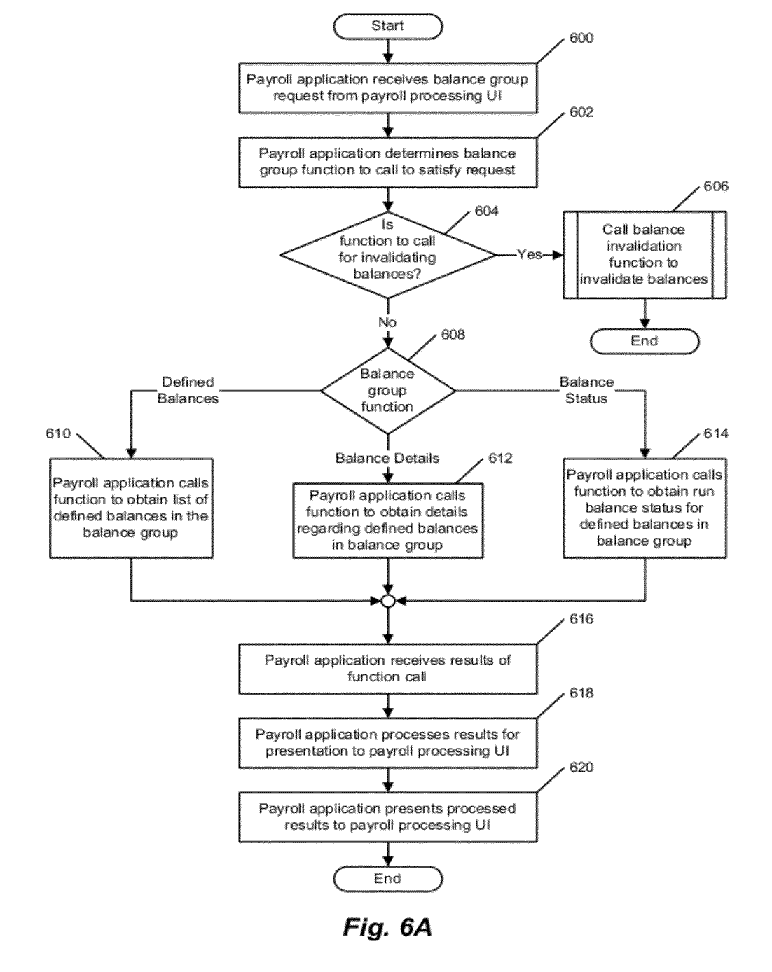

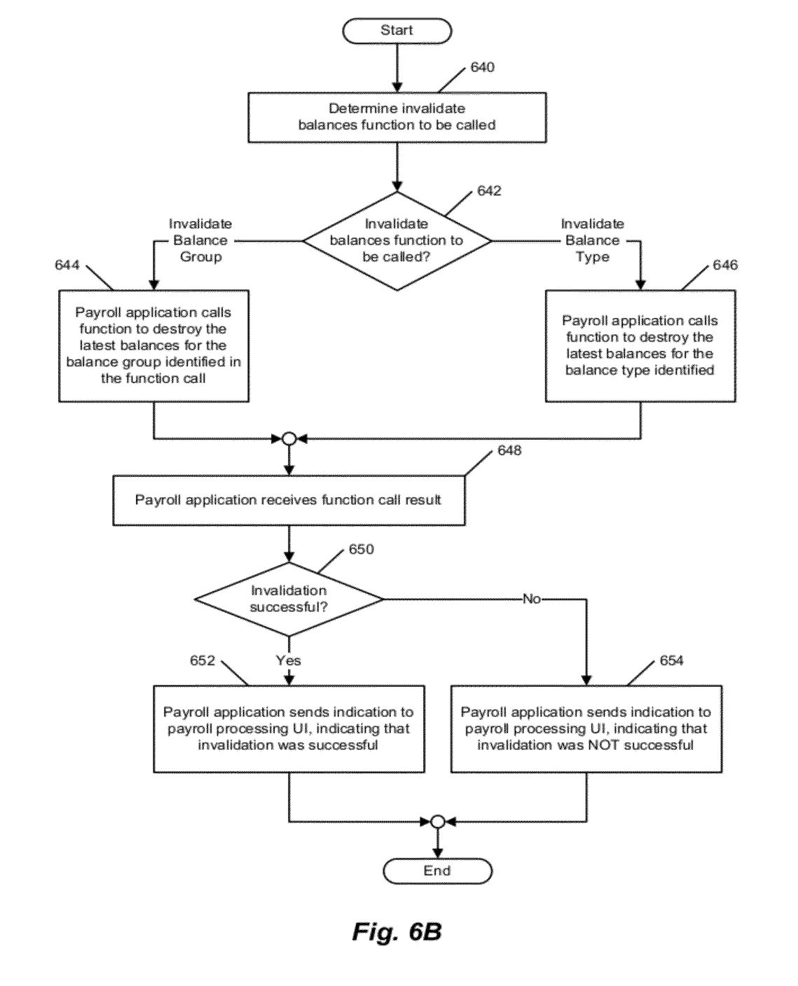

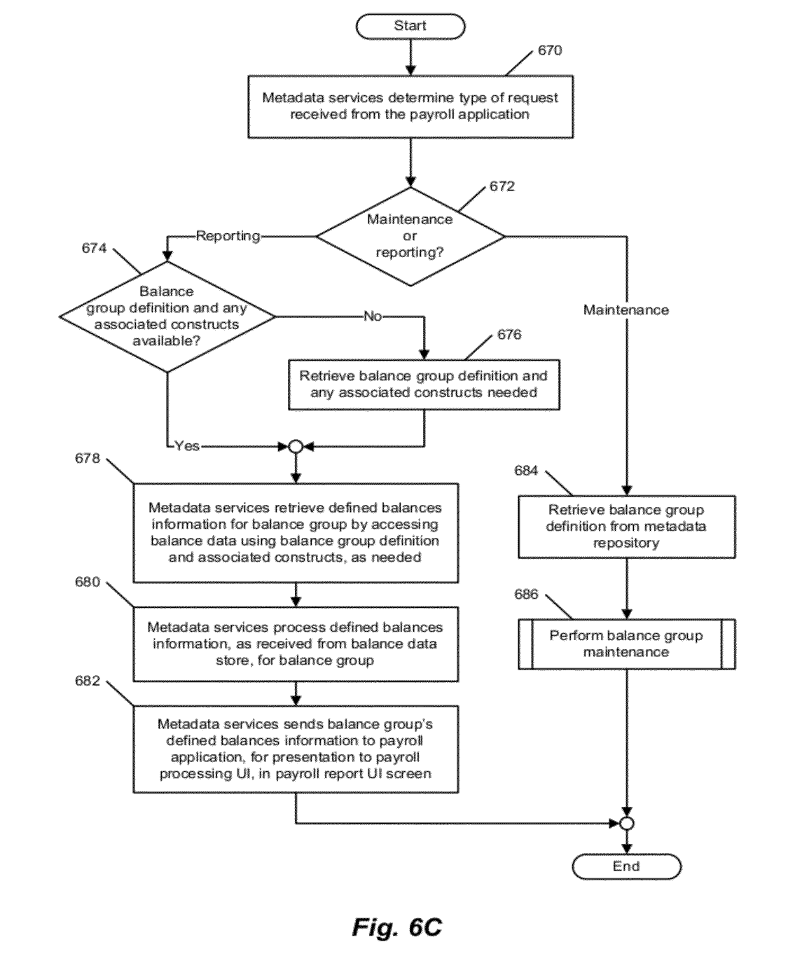

Metadata services 430 also accesses a metadata repository 455, which provides metadata services 430 with access to metadata constructs stored in metadata repository 455. As is illustrated in FIG. 4, then, metadata services 430 not only employs balance group definition 440 in providing data from balance data store 450 to report generation module 422 of payroll application 420, but is also tasked with the maintenance of balance group definition 440 in metadata repository 455. As discussed in greater detail subsequently, in connection with the discussion of FIGS. 6A, 6B, 6C, 7, 8, 9, and 10, payroll processing performed via payroll processing UI 405 and payroll management operations performed via payroll management UI 410 are addressed by metadata services 430, at least in part, through its use and maintenance of balance group definition 440.

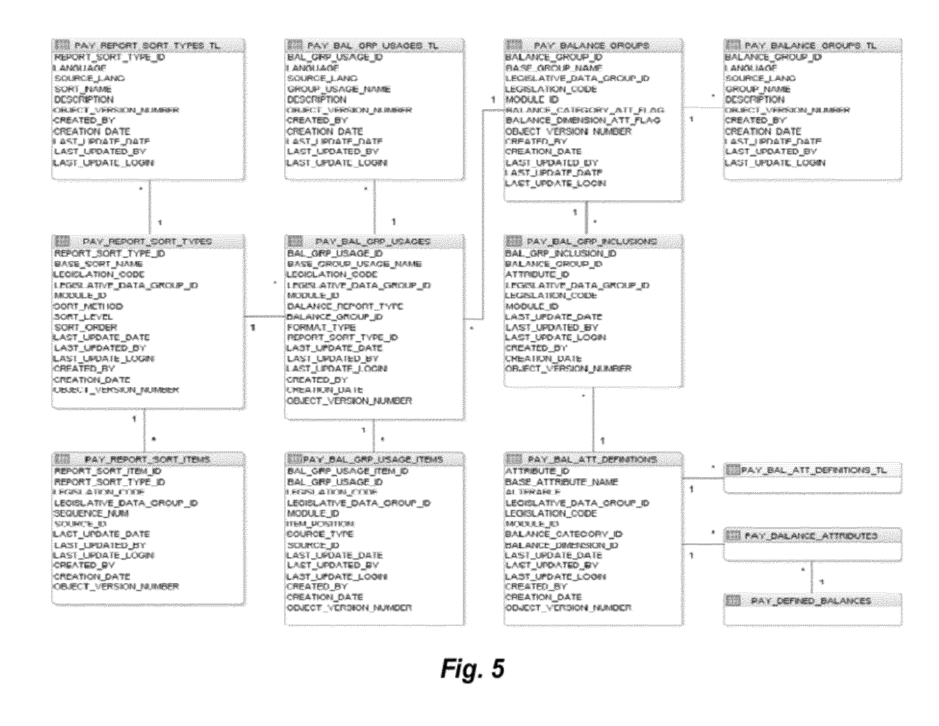

FIG. 5 is a block diagram illustrating an example of a data model according to the present invention. The data model of FIG. 5 is provided as an example of the data structures that can be used to practice various embodiments of the present invention. As can be seen, the data model of FIG. 5 reflects a number of tables that support balance group functionality, and also reflects various physical data model entities, as well.

FIG. 6A is a flow diagram illustrating an example of the operations performed in a payroll application architecture such as payroll architecture 400, according to the embodiment of the present invention, in processing payroll, using one or more balance groups as may be defined by a balance group definition such as balance group definition 440. The process begins with the receipt of a balance group request from, for example, a payroll processing UI, a payroll application such as payroll application 420 (step 600). More particularly, an end-user who desires one or more payroll reports can use a payroll report UI screen such as payroll report UI screen 406 to access a report generation module, and so the requisite balance data, via metadata services capable of supporting balance groups. The payroll application then determines which balance group function to call to satisfy the request (step 618). Once this determination has been made, the request is examined to determine whether the function that is to be called is directed to invalidating balances (step 604). If the function that has been requested is an invalidation function (step 604), one of the balance invalidation functions is called to invalidate the balances in question (step 606). The operations performed in invalidating one or more balances are described in further detail in connection with the discussion of FIG. 6B.

If the request received by the payroll application is not directed to balance invalidation (step 604), a determination is then made as to which of the remaining balance group functions the request is indicated should be performed (step 608). If the balance group function to be performed is an inquiry as to the defined balances of those balances in the balance group, the payroll application calls the requisite function which returns a list of the defined balances in the balance group (step 610). Alternatively, if the balance group function requested is an inquiry as to the balance details of the balances in the balance group (step 608), the payroll application calls a balance detail function which provides details regarding the defined balances in the balance group (step 612). In the further alternative, the request received by the payroll application may indicate that the balance group function to be performed is a balance status (step 608), in which case the payroll application calls a function that contains the run balance status for the defined balances in the balance group (step 614). As will be appreciated, the balance group functions presented in connection with FIG. 6A are merely examples of a wide variety of balance group functions that might be implemented in a payroll application architecture such as payroll application architecture 400, and as such, are not intended to be limiting in any way.

Once the requisite actions have been taken to satisfy the requested balance group function, the payroll application receives the results of the function call (e.g., from a metadata layer entity such as metadata services 430) (step 616). If any processing is needed or requested at the application layer, the payroll application processes the result in preparation for presentation of those results to the payroll processing UI (step 618). Once any such processing has completed, the payroll application presents the processed results to the payroll processing UI (step 620).

FIG. 6B is a flow diagram illustrating an example of the operations that can be performed in satisfying a request directed to balance invalidation of the defined balances in the balance group in question. As indicated previously, the operations depicted in FIG. 6B are examples of the balance invalidation functions noted in connection with FIG. 6A (step 606). Moreover, while FIG. 6B depicts an invalidate group operation and an invalidate balance type operation, it will be appreciated that these operations are presented merely as examples of the wide variety of invalidation operations that might be supported by a payroll application architecture such as payroll application architecture 400. The processing of a balance invalidation function request by a payroll application begins with a determination as to the balance invalidation function to be invoked (step 640). A decision is then made based on this determination (step 642), and, in FIG. 6B, results in a determination as to whether the requested balance invalidation function is an invalidate balance group function or an invalidate type function. If the invalidate balances function to be called is an invalidate balance group, the payroll application calls the function that destroys the latest balances for the balance group identified in the function call (step 644). Alternatively, if the invalidate balances function to be called is an invalidate balance type (step 642), the payroll application calls a function that destroys the latest balances for the balance type identified in the call (step 646). Once the requisite invalidate balances function has been performed, the payroll application receives the result of the function call (step 648). This function call result is then examined to determine whether or not the invalidate balances function completed successfully (step 650). If the invalidate balances function completed successfully (step 650), the payroll application sends an indication to the payroll processing UI, indicating the invalidation was successful (step 652). However, if the payroll application receives a function call result that indicates that the invalidate balances function did not complete successfully (step 650), the payroll application sends an indication to the payroll processing UI, indicating that invalidation was not successful (step 654).

FIG. 6C is a flow diagram depicting an example of the operations performed by a metadata layer entity such as metadata services 430 employing balance group concepts according to embodiments of the present invention, such as those described herein (an example of which is balance group definition 440). The process of FIG. 6C begins with the metadata services making a determination as to the type of access requested by the payroll application (step 670). A determination is then made as to whether the payroll application has requested maintenance or reporting operations (step 672). As will be appreciated from FIG. 4, this determination can hinge not only on the request being made but, in certain implementations, on the component of payroll application architecture 400 from which the request is received. As will be appreciated upon review of FIG. 4, a reporting request is received from payroll processing UI 405 (and, in particular, payroll report UI screen 406) via report generation module 422. Alternatively, a maintenance request would typically be received from payroll management UI 410 (and more specifically, balance group view screen 411) via payroll management module 424. As will also be appreciated, a request for report generation result in the use of balance group definition 440 in metadata services 430 accessing balance data store 450. In the alternative, once again, if maintenance is to be performed on a balance group (e.g., as might be defined by balance group definition 440) metadata services 430 access metadata repository 455 (in the case in which balance group definition 440 is not already available to metadata services 430), and perform the requisite maintenance operations thereon

In light of the foregoing, a request received from the payroll application for a reporting operation (step 672), results in a determination as to whether the balance group definition in question (as well as any of its associated constructs) is available (step 674). If the requisite balance group definition and/or any associated constructs are not available, these are retrieved from metadata repository 455 (step 676). If the balance group definition in question (and any associated constructs) are available (or have been retrieved), the metadata services retrieve the defined balances information for the balance group defined by the balance group definition, by accessing balance data in balance data store 450, using the balance group definition and its associated constructs, as needed (step 678). Once the metadata services have retrieved the defined balances information in this manner, the metadata services perform any processing of the defined balances information, as may be required, such that the process defined balances information is ready to be provided to the payroll application (step 680). The metadata services then send the balance group's defined balances information to the payroll application for presentation to the payroll processing UI, in the payroll report UI screen (step 682).

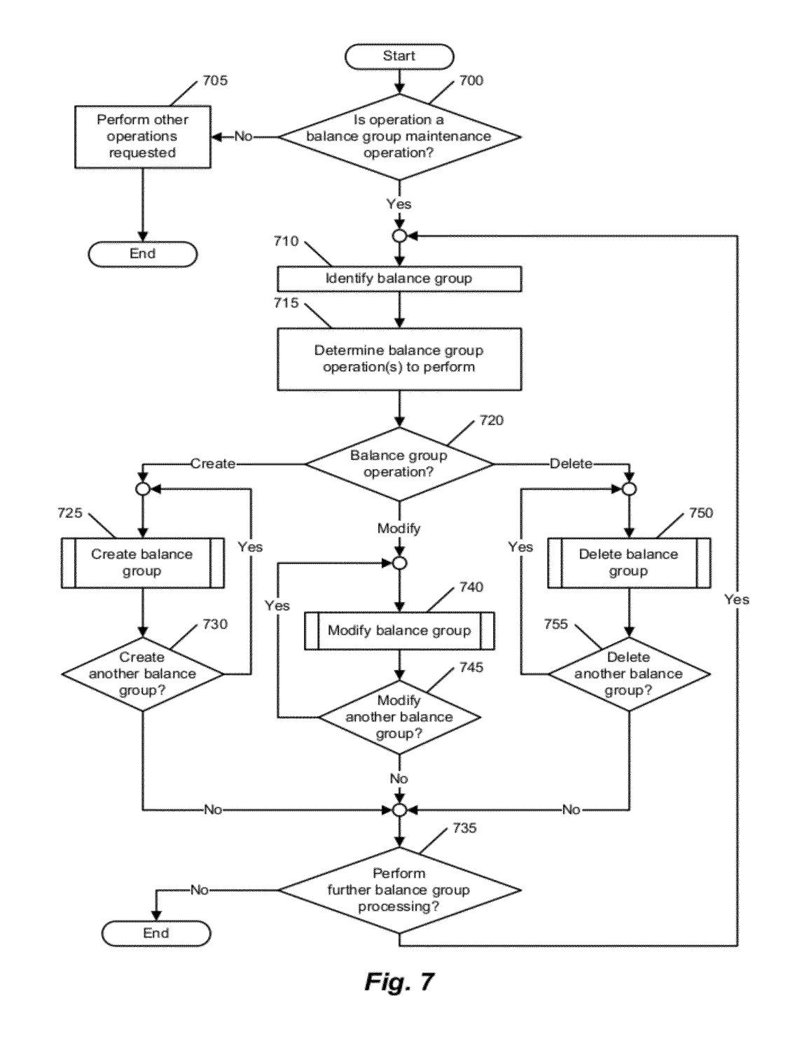

If the request received from the payroll application indicates that the metadata services should perform (or caused to be performed) a maintenance operation (step 672), the balance group definition to be maintained is retrieved from the metadata repository (step 684). Having retrieved the balance group definition in question, the metadata services then perform balance group maintenance thereon (step 686). Examples of such balance group maintenance operations are described in further detail in connection with the example operations presented in FIGS. 7, 8, 9, and 10.

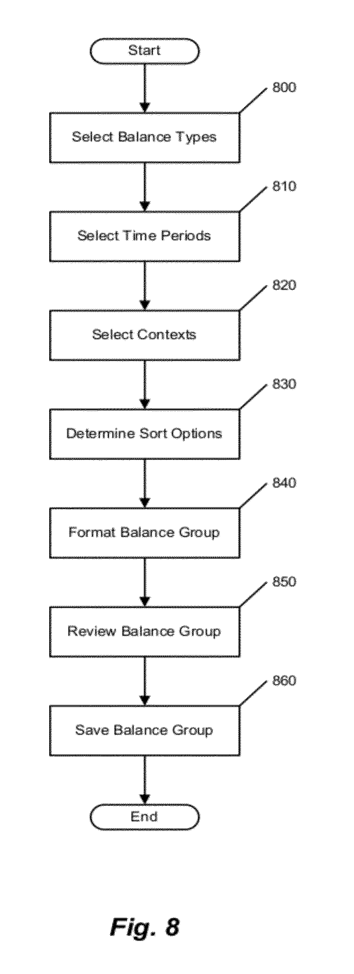

FIG. 7 is a flow diagram illustrating an example of the operations by a metadata layer entity such as metadata services 430, according to embodiments of the present invention, in performing maintenance operations such as those noted in connection with FIG. 6C (at step 686). The process depicted in FIG. 7 begins with a determination by metadata services 430 as to whether the operation to be performed is a balance group maintenance operation (step 700). If the operation to be performed is not a balanced group maintenance operation, metadata services 430 perform this other operation, as requested (step 705). It is to be appreciated that such other operations are not the subject of this disclosure, and so no further detail is provided in this regard. If the operation to be performed is a balance group maintenance operation (step 700), however, the balance group on which metadata services 430 is to perform maintenance is identified (step 710). A determination is then made as to the balance group operation(s) there to be performed (step 715). It will be appreciated, at this point, that the operations now described are presented merely as examples of such balance group operations, should not be considered in any way limiting. The aforementioned determination as to the balance group operation(s) to be performed results in metadata services 430 identifying the balance group operation (step 720). If the requested balance group operation is directed to the creation of a balance group, the process proceeds to the create balance group sub-process (step 725). An example of a create balance group operation is described in further detail in connection with the discussion of FIG. 8. A determination is then made as to whether additional balance groups are to be created (step 730). If other balance groups remain to be created, the process loops to the create balance group sub-process (step 725), and metadata services 430 perform the requisite operations to create the requested balance group. Once the requested balance groups have been created, a determination is made as to whether further balance group processing remains to be performed by metadata services 430 (step 735). If no further balance group processing is needed, the process concludes, or, in the alternative, the process loops to the beginning and again makes a determination as to the balance group (step 710) and the balance group operation(s) (step 715) to be performed.

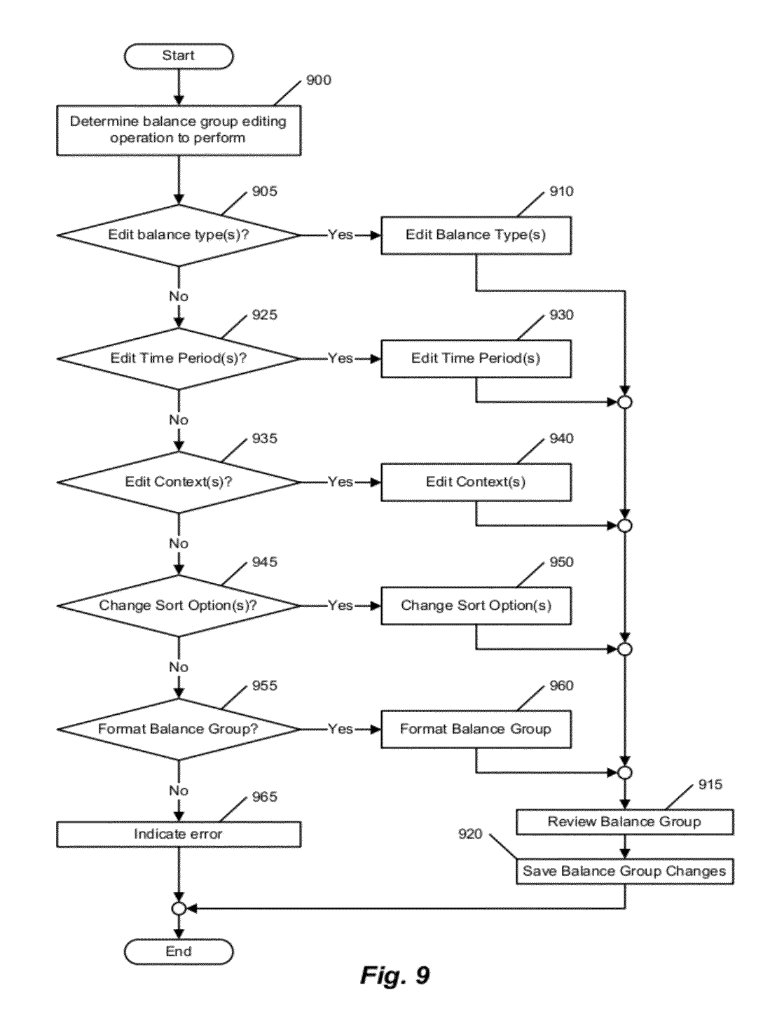

If the balance group operation to be performed is a modified balance group operation (step 720) the process proceeds to a modify balance group sub-process (step 740). An example of a modify balance group operation is described in greater detail in connection with the process depicted in FIG. 9 and its accompanying discussion. Once the requested modify balance group operation has been performed (step 740), a determination is made as to whether any other balance groups remain that are to be modified as well (step 745). If so, the process loops to the modify balance group operation sub-process (step 740), and if not, the process proceeds to the determination as to the need for performing further balance group processing (step 735). As before, if no further balance group processing is needed (step 735), the process concludes. Otherwise, the process loops back to the beginning and processes the next balance group operation(s).

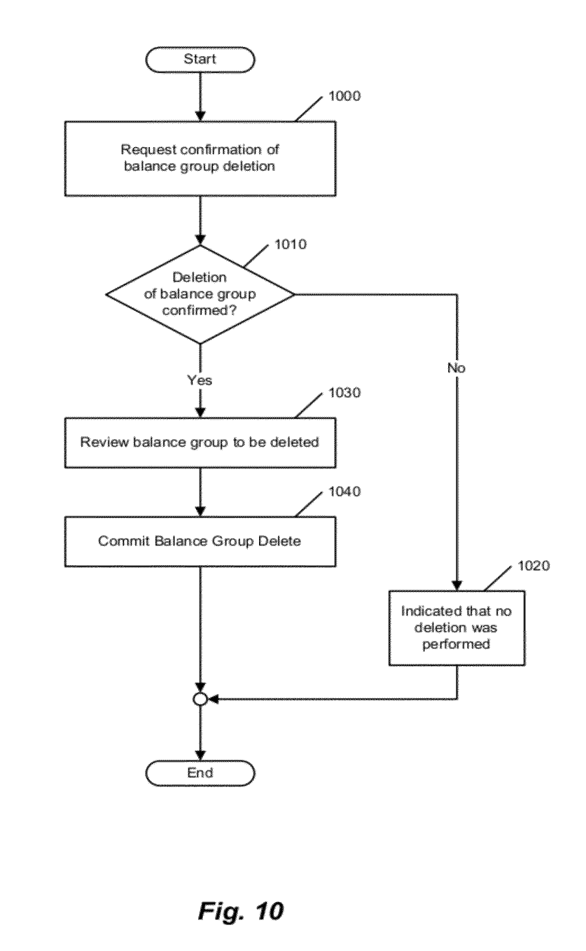

If the balance group operation(s) to be performed is a delete balance group operation (step 720), a delete balance group operation is performed by metadata services 430, as indicated by the delete balance group sub-process of FIG. 7 (step 750). An example of a delete balance group operation is presented in connection with FIG. 10 and its associated discussion. Once the requested delete balance group operation has been performed, a determination is made as to whether other delete balance group operations remain to be performed (step 755). As before, once the requested delete balance group operations have been performed, the process determines whether any further balance group processing is needed (step 735). If no such processing is needed, the process concludes, and otherwise, loops back to the beginning to process the next balance group operation(s).

FIG. 8 is a flow diagram illustrating an example of a process of creating a balance group, according to embodiments of the present invention, as noted earlier in connection with FIG. 7 (at step 725). The process begins with the selection of one or more balance types for the balance group (step 800). Next, the time periods for which the balance group is to be effective is selected (step 810). Once the balance types and time periods have been selected, the context in which the balance group is to operation is selected (step 820). Next, a determination is made as to whether, if any, sort options are needed to support the functionality to be provided by the balance group in question (step 830). A format type for the balance group is then selected (step 840), which indicates the format in which the defined balance information is organized upon its being returned to the payroll application. Examples of such formats include a matrix table and a single table. Next, the balance group created is reviewed to ensure that the desired information is returned in the expected and desired manner (step 850). Once the new balance group has been reviewed, the balance group is then saved, for example, to a metadata repository such as metadata repository 455 (step 860), after which the process concludes.

FIG. 9 is a flow diagram illustrating an example of a process for editing an existing balance group, according to embodiments of the present invention, as noted in connection with FIG. 7 (at step 740). The process of editing a balance group depicted in FIG. 9 begins with a determination as to the balance group editing function to be performed (step 900). Once the balance group editing operation has been identified, various determination are made as to which balance group characteristic is to be edited. For example, one or more balance types may be added to or removed from the balance group in question, and so a determination is made as to whether such an operation is to be performed (step 905), and if so, the balance group's balance type(s) is edited as desired (step 910). As depicted in FIG. 9, the process then proceeds to a review of the edited balance group (step 915). If the changes to the balance group are acceptable, those changes are saved (e.g., in a metadata repository such as metadata repository 455) (step 920).

In a similar fashion, a determination is made as to whether one or more time dimensions are to be added to or removed from the balance group in question (step 925). If so, the requisite time dimension(s) are added to and/or removed from the balance group in question (step 930). The process then proceeds, as before, a review of the edited balance group and, assuming such changes are acceptable, those changes being saved (steps 915 and 920). Determinations are also made as to whether balance contexts are to be added to or removed from the balance group in question (step 935), and if so, the addition or removal of the time dimension(s) to/from the balance group in question are performed (step 940). The sequence or sort-type required for displaying the balances of the balance group can also be changed, if desired (steps 945 and 950). Additionally, the format of the results produced by the balance group can be edited (steps 955 and 960). As failsafe, if the requested editing operation to be performed on the balance group in question is not among those editing operations supported by the given implementation, an error can be indicated to metadata services 430 for further processing (and possible presentation to the user of payroll management UI 410) (step 955), after which the process concludes.

FIG. 10 is a flow diagram illustrating an example of a delete balance group operation, according to embodiments of the present invention, as noted in connection with FIG. 7 (at step 750). The process of deleting a balance group begins, in the scenario depicted in FIG. 10, with a requested for confirmation as to the deletion of the balance group (step 1000). If the performance of the delete balance group operation is not confirmed (step 1010), an indication that no such deletion has been performed is provided to payroll application 420 by metadata services 430, for further processing (step 1020). If the deletion of the given balance group is confirmed (step 1010), the balance group to be deleted is reviewed (step 1030). Once reviewed, the balance group delete operation is performed (e.g., by committing the balance group deletion to the metadata repository in which the balance group definition had been maintained) (step 1040), after which the process concludes.

### Example Details of Balance Group Functions

In one implementation, various procedures (balance group functions) are provided to support the balance group functionality described earlier in connection with FIGS. 6A, 6B and 6C, for example. Advantageously, such procedures provide a common approach to retrieving balance group information for the various groups that are typically tasked with maintaining payroll systems. Such procedures include, for example:
Retrieve defined balances of balance group (get_bal_grp_members)—supply a balance group usage name and return a table containing a list of all of the defined balances which are in a balance group. If a sort has been defined for the usage(s), the defined balances are returned in the specified sort order.
Retrieve balance details of defined balances of balance group (get_def bal_details)—supply a defined balance list and return additional defined balance details such as balance type name, balance dimension name, balance dimension identifier, database item suffix, and other such details.
Retrieve balance status of defined balances of balance group (get_bg_run_balance_status)—for each defined balance in a balance group return a list of these defined balances with their run balance status.
Invalidate balances in defined balances of balance group (invalidate_latest_balances_{—}1)—This procedure destroys the latest balances for a balance group where the latest balance date is after the date provided to the function as a parameter.
Invalidate balances in defined balances of balance group based on balance type (invalidate_latest_balances_{—}2)—Overloaded version of invalidate_latest_balances_{—}1 for balance type identifier. This procedure destroys latest balances for the balance type indicated, where the latest balance date is after the date provided to the function as a parameter.
Other utility functions that support the balance group functionality.

The aforementioned procedures are described in the following tables.

TABLE 1
Balance group function get_bal_grp_members.

| | |
|---|---|
| Name | get_bal_grp_members |

Arguments

| Name | Type |
|---|---|
| p_base_group_usage_name | varchar2(80) |
| p_bg_balance_list (OUT) | Table pay_balance_list_tab_t |

| | |
|---|---|
| Description/ | This procedure returns a table containing a list of the defined balances in the balance |
| Behavior | group. If a sort has been specified for the usage(s) the defined balances are returned in |
| | the specified sort order. Note that more than one usage can exist with the same name |
| | (e.g., where a particular process, e.g., statement-of-earnings, uses multiple balance |
| | groups, the usage name is the same for all of the balance groups). Typically used by |
| | screens and reports to get the list of defined balances for displaying. |
| Example | Get all of the pay_bal_grp_usages using the parameter |
| Pseudo-Code | p_base_group_usage_name. |
| | For each pay_bal_grp_usages found : |

check the pay_bal_grp_usage_items to verify what dimensions are applicable
for this usage
get the pay_balance_groups using balance_group_id
get the pay_bal_grp_inclusions using balance_group_id
get the pay_bal_att_definitions using attribute_id
get all pay_balance_attributes
for each pay_balance_attribute

verify (from usage_item information) that the defined balance is applicable

for this usage

update the PL/SQL table with the defined_balance_id and the

base_group_name (this is the balance group name).

get the pay_report_sort_types

if sort_method is Name then

get balance name for each defined balance
sort in balance name order

if sort_method is Static Order then

if sort_level is BT then sort items are balance types and sort in balance type

order

if sort level is DB then sort items are defined balances and are specified in

the required order in sort items

if sort_method is value then

call get_value for defined balances using PL/SQL table as input
sort in balance value order

update PL/SQL table with sorted results

| | |
|---|---|
| Object Types | |
| | PAY_BALANCE_LIST_REC_T |

| Name | Type |
|---|---|
| DEFINED_BALANCE_ID | NUMBER |
| BASE_GROUP_NAME | VARCHAR2(80) |

Table Types

PAY_BALANCE_LIST_TAB_T

Table of PAY_BALANCE_LIST_REC_T

TABLE 2
Balance group function get_def_bal_details.

| | |
|---|---|
| Name | get_def_bal_details |

Arguments

| Name | Type |
|---|---|
| p_Defined_Balance_List | Table pay_balance_value_tab_t |
| p_Balance_Details_List (OUT) | Table pay_balance_details_tab_t |

| | |
|---|---|
| Description/ | This procedure returns a table containing additional balance and dimension details |
| Behavior | using a list of defined balance identifiers as input. Typically used by screens and |
| | reports that want more balance details than just a balance value. |
| Example | For each defined balance identifier obtain the balance_type_id from |

| | |
|---|---|
| Pseudo-Code | pay_balance_types. |

For each balance_type_id obtain the balance_name from pay_balance_types_tl.
For each defined balance identifier obtain the balance_dimension_id and period_type

from pay_balance_dimensions.

For each balance_dimension_id obtain the dimension_usage_id, database_item_sufix

from pay_dimension_usages for the appropriate legislation_code.

For each dimension_usage_id obtain the dimension_name from

pay_dimension_usages_tl for the appropriate language.

| | Update output table with the values. |
|---|---|
| Object Types | |
| | PAY_BALANCE_VALUE_REC_T |

| Name | Type |
|---|---|
| DEFINED_BALANCE_ID | NUMBER |
| BALANCE_VALUE | NUMBER |

PAY_BALANCE_DETAILS_REC_T

| Name | Type |
|---|---|
| DEFINED_BALANCE_ID | NUMBER |
| BALANCE_VALUE | NUMBER |
| BALANCE_TYPE_ID | NUMBER |
| BALANCE_NAME | VARCHAR2(80) |
| BALANCE_DIMENSION_ID | NUMBER |
| DATABASE_ITEM_SUFFIX | VARCHAR2(80) |
| DIMENSION_NAME | VARCHAR2(80) |
| PERIOD_TYPE | VARCHAR2(30) |

Table Types

PAY_BALANCE_VALUE_TAB_T
Table of PAY_BALANCE_VALUE_REC_T
PAY_BALANCE_DETAILS_TAB_T

Table of PAY_BALANCE_DETAILS_REC_T

TABLE 3
Balance group function get_bg_run_balance_status.

| | |
|---|---|
| Name | get_bg_run_balance_status |

Arguments

| Name | Type |
|---|---|
| p_base_group_usage_name | varchar2(80) |
| p_bg_status_list (OUT) | Table pay_balance_status_list_tab_t |

| | |
|---|---|
| Description/ | This procedure returns a table containing all of the defined balances for a balance |
| Behavior | group with the run balance status for each defined balance. |
| | Can be used by the balance groups UI to display the run balance status when |
| | adding/updating balances in a balance group. |
| Example | Get all of the pay_bal_grp_usages using the parameter p_base_group_usage_name. |
| Pseudo-Code | For each pay_bal_grp_usages found |

get all of the defined balances
for each defined balance check the run balance status
update PL/SQL table with defined balance and run balance status

| | |
|---|---|
| Object Types | |
| | PAY_BALANCE_STATUS_LIST_REC_T |

| Name | Type |
|---|---|
| DEFINED_BALANCE_ID | NUMBER |
| BASE_GROUP_NAME | VARCHAR2(80) |
| RUN_BALANCE_STATUS | VARCHAR2(1) |

Table Types

PAY_BALANCE_STATUS_LIST_TAB_T

Table of PAY_BALANCE_STATUS_LIST_REC_T

TABLE 4
Balance group function invalidate_latest_balances_1.

| | |
|---|---|
| Name | invalidate_latest_balances_1 |

Arguments

| Name | Type |
|---|---|
| p_Balance_Group_ID | number |
| p_Invalidate_Date | date |

| | |
|---|---|
| Description/ | This procedure destroys all latest balances for a balance group where the latest balance |
| Behavior | date is after the parameter date. |
| Example | For the pay_balance_group |

| | |
|---|---|
| Pseudo-Code | get the pay_balance_groups using balance_group_id |
| | get the pay_bal_grp_inclusions using balance_group_id |
| | get the pay_bal_att_definitions using attribute_id |
| | get all pay_balance_attributes |
| | get all defined balances |
| | for each defined balance |

delete rows from pay_latest_balances which have the defined
balance identifier

TABLE 5
Balance group function invalidate_latest_balances_2.

| | |
|---|---|
| Name | invalidate_latest_balances_2 |

Arguments

| Name | Type |
|---|---|
| p_Balance_Type_ID | number |
| p_Invalidate_Date | date |

| | |
|---|---|
| Description/ | Overloaded version of invalidate_latest_balances for balance type identifier. This |
| Behavior | procedure destroys all latest balances for a balance type, where the latest balance date |
| | is after the parameter date. |
| Example | For the pay_balance_group |

| | |
|---|---|
| Pseudo-Code | get the pay_balance_groups using balance_group_id |
| | get the pay_bal_grp_inclusions using balance_group_id |
| | get the pay_bal_att_definitions using attribute_id |
| | get all pay_balance_attributes |
| | get all defined balances |
| | for each defined balance |

delete rows from pay_latest_balances which have the defined
balance identifier

### Example Balance Group Definitions

In order to be able to share balance groups, it is preferable to define balance groups at the lowest level that the balance groups will be needed (e.g., by a team or localization) unless a hierarchy for the balance groups is defined. For example; if a localization has a report that requires balances for all charges, another report that requires employee charges, and another report that requires employer charges, and there is no need to define an “all-charges” balance group, the employee charges and the employer charges balance groups should be used. As will be appreciated, a balance group contains the defined balances that exist in a balance group. A balance group usage defines how the defined balances in the balance group are used by a particular process.

### Balance Group Items

Legislation Code: Used if operation using the new balance group is a localization operation. (This field is not relevant for cross-localization operations.)
Base Group Name: The name of the balance group
Balance Group Description: Description of the balance group, the type of balances it is expected to contain, and the like.

Group Name: The translatable name of the Base Group Name. Stored in the pay_balance_groups_μl table.
Category Flag: If set to Y, this indicates that at least one category is defined in the pay_bal_att_definitions to restrict balances being added to the balance group to be only of those category(s).
Dimension Flag: If set to Y, this indicates that at least one dimension is defined in the pay_bal_att_definitions to restrict balances being added to the balance group to be only of those dimension(s).
Balance Categories: If Category Flag is set to Y, this item defines the balance category(s) a balance type should be in, in order to allow the balance category(s) to be added to the balance group.
Balance Dimensions: If Dimension Flag is Y, this item defines the balance dimension(s) a defined balance should be, in order to allow the defined balance to be added to the balance group.
Balances: If seeded defined balances are known, then such are indicated here. Defined balances aren't necessarily known when defining Balance Groups.
Balance Report Type: The name of the process that is to use this balance group. This name is used by the calling process to identify the balance group to be accessed. These values are stored within a lookup table that are maintained, for example, by global payroll. This lookup table is extensible, which allow localizations, and also end-users, to add their own values. It should be noted that this field is optional, there should be no situations in which a balance group usage would be created without associating that balance group with a report/screen, but the option is there to do so.

### Balance Group Usage Items

Base Group Usage Name: The name of the balance group usage. It will be noted that there can be one usage occurrence for each balance group that is required in each screen/report/process.
Usage Description: Description of the balance group usage, which should indicate what process uses the balance group and how the balance group is used.
Format Type: The format type determines how the underlying balance group usage structure is created (i.e., occurrences of the pay_bal_grp_usage_items table are only created if the format type is matrix).
Format type values are:
   Table—used when there's one balance region on the screen/report
   Multiple—used when there's multiple balance regions on the screen/report, each region with its own balances.
   Matrix—used when the balances are displayed in a matrix type format (e.g., balances displayed down the page and the dimensions across the page).
Group Usage Name: The translatable name of the base group usage name. Stored in the pay_bal_grp_usages_t1 table.
Comments: Any additional comments that may be useful.

### Sort Types and Items

There is only one sort type definition for a given balance group usage. However, when the sort method is static, localizations can/will define sort items for that sort type. It will be noted that, in certain implementations, one schema supports multiple sorts per balance group usage so a localization can define its own sort(s) for a balance group usage.

The following values for SORT_METHOD can be defined:
NAME: sort by name specified in sort_level (can only be BT or BD)
VALUE: sort by balance value
STATIC: specify the items in the required order. If this is specified, the sort level should be defined. Sort Level indicates what values are stored in the source_id column in the sort items table. For example, if sort_level=BT and sort_method=STATIC, then define sort items with specific balance_type_ids in the source_id column.

The following values for SORT_LEVEL can be defined:
DB: specify the defined balances (DB) in sort items in the required sort order. It will be noted that this value of sort_level is not valid for usage groups with a format_type of matrix.
BT: balance types (BT)
BD: balance dimensions (BD)

The following values for SORT_ORDER can be defined:

ASC: sort the objects in ascending order.

DESC: sort the objects in descending order.

If the sort_level is DB, and one or more of the defined balances in the balance group are not defined, the still-undefined defined balances are returned with a null value for the sort position. Thus, the sort order determines where these defined balances are positioned. If the sort order is ASCending, the balances and their values appear at the end of the returned table; if the sort order is DESCending, the balances and their values appear at the start of the returned table.

### Seeded Balance Groups

Balance groups can be seeded by various global and cross-localization operations (e.g., statement-of-earnings operations, archiving operations, and the like). These balance groups are global (i.e., no localization code or legislative_data_group_id is populated in the balance group tables). It should be noted that this includes the attribute definition tables. If the balance group is global, the attribute definitions should also be global. Localizations can seed their own balance groups where necessary (e.g., for specific reports that are written). However, where possible, global balance groups should be used.

### Overriding Seeded Balance Groups

Localizations typically do not need to override the global seeded balance groups. These balance groups are at a global level and any necessary localization-defined balances are added to the global balance groups by the localization, and therefore have the legislation code set. Therefore, because the localization adds the required defined balances to the global balance group(s), there should be no need from a localization point of view to override the global balance groups.

Similarly, it is not expected that end-users need the ability to override any of the global balance groups which have had defined balances associated with them. Typically, the defined balances from such global balance groups cannot be removed because these are generally seeded (being required for statutory processing). It is therefore undesirable for end-users to be able to remove them. However, end-users have the ability to add balances to these global balance groups, if required. The ALTERABLE field on the PAY_BAL_ATT_DEFINITIONS table indicates whether or not end-users can add to the balances in a seeded balance group. The PAY_BAL_ATT_DEFINITIONS table can have a many-to-many relationship with a balance group (which can occur if the balance group is restricted by balance categories or dimensions). In this case, the appropriate PAY_BAL_ATT_DEFINITIONS occurrence can be verified that the occurrence has the ALTERABLE flag set. Localizations and end-users can override any seeded global sort types by defining a sort type at the localization or user level. The balance group utilities check for the existence of an end-users or localization sort before using the global one. Balance group functionality is flexible and caters to common usage across all areas where balances are displayed or retrieved. As a result, there are no hard-and-fast rules about which balance groups are used in which situations.

Balance groups can include defined balances of different period types (e.g., period-to-date, month-to-date, year-to-date, and so on), and can be any combination of balances, depending purely on where the balances need to be displayed/retrieved. For example, a statement-of-earnings screen can have several balance regions on the screen. Such balance regions can define balance groups for each region along the lines of: GLB_EARNINGS, GLB_DEDUCTIONS, GLB_EMPLOYER_CHARGES, and so on. Each of these balance groups can, for example include earnings balances, deductions balances, and employer charges balances, respectively. These balance groups can also be made up of different time periods. For example, the earnings balances could contain PTD and YTD dimensions.

The following describes what is stored in the database to achieve the balance group functionality. When defining balance group information for a localization the following tables are populated:

PAY_BALANCE_GROUPS—balance group definition.

PAY_BALANCE_GROUPS_TL—translatable balance group name.

PAY_BAL_GRP_INCLUSIONS—link to the attribute definition.

PAY_BAL_ATT_DEFINITIONS—attribute definition. Required if adding localization balances to a localization balance group, and cannot be populated for a global balance group (for global balance groups, the global attribute definitions are used).

PAY_BAL_GRP_USAGES—a particular occurrence of the usage of a balance group by a process.

PAY_BAL_GRP_USAGES_TL—translatable balance group usage name.

PAY_BAL_GRP_USAGE_ITEMS—stores information about what defined balances are applicable for a balance group usage. This table also defines the display order for the columns in a matrix display usage. For example, if source_type=BD (Balance Dimension), the usage_items define the balance dimensions that be displayed for the balance group usage. If usage_items are defined for, e.g., dimensions _ASG_MTD, _ASG_TU_MTD, _ASG_YTD, and _ASG_TU_YTD, then only defined balances with those dimensions be returned, regardless of the defined balances associated with the balance group. It will be noted that pay_bal_grp_usage_items is only applicable for balance group usages with a format type of matrix. It will also be noted that rows in this table are defined for balance group usages with a format type of matrix. Values are only returned from core functions (such as get_bal_grp_values_matrix) for defined balances which meet the usage_items criteria.

If sorting is required:

PAY_REPORT_SORT_TYPES—Sort definition for a balance usage.

PAY_REPORT_SORT_ITEMS—If sort is of a certain type then this table contains references to the individual balance sort details.

Balance groups usage items are defined as part of localization because such usage items define the dimensions for the localization display on each UI/report/process. The usage items are not stored in the master spreadsheet and are maintained by localizations. Localizations should maintain their own seed data spreadsheet for localization-specific information, such as balance groups, balance group usage items, balance types, defined balances, and so on. If the format type is matrix, usage items are defined. The usage items control the dimensions that are used in the balance group usage and for a UI, the position of the dimension columns within the screen. If the format type is table, then usage items are not defined.

Source Type—e.g., BD.

Source Identifier—The surrogate key identifier of the parent record. For example, if SOURCE_TYPE=BD then source_id represents a balance_dimension_id. Each dimension that is to be used in the balance group usage is specified here.

Position—the position of the column displayed in the UI. Optional.

Multiple dimensions can be specified in the same position, thereby allowing multiple dimensions to be displayed in the same column.

Balance categories are used in conjunction with balance dimensions to default defined balances to balance group(s). When a defined balance is created, either through the balance definition UI, or through the element template process, the balance category and balance dimension associated with the defined balance be used to determine if any defaulting has been defined for this combination. If any defaulting is found, the defined balance is added to the appropriate Balance Groups. The defaulting is handled by the pay_bal_att_defaults table.

Defaulting information for global balance groups can be defined by core payroll. Localizations are not able to seed default details for global balance groups, as this is done by core payroll. If a localization is to default balances to localization balance groups, the necessary information is seeded in pay_bal_att_definitions.

The following tables present examples of the data that can be stored in the balance group tables for various cases. The balance group information can be entered, for example, through a spreadsheet loader or loaded through the seed data framework through XML files. This includes the creation of the balance attributes and the association of the balances to balance attributes. There can be a lookup table which contains the permitted values of pay_bal_grp_usages.balance_report_type, indicating the process/report/screens that are using which balance groups.

Where Legislation_Code and Legislative_Data_Group_Id are null in these examples, this indicates a global balance group and/or global balance group usages. If the balance groups and/or balance group usages were defined by a localization or end-user, the legislation_code or legislative_data_group_id would be non-null. It is possible for localizations and end-users to define balance group usages against a global balance group.

### Example Balance Group Table Definitions

Example Balance Group with Format Type Table

Example definition of the earnings balance group that's used in the statement-of-earnings screen. The example balances displayed are US balances. Format Type is Table, so pay_bal_grp_usage_items is not populated.

PAY_BALANCE_GROUPS

| Column Name | Description |
|---|---|
| BALANCE_GROUP_ID | generated primary key |
| BASE_GROUP_NAME | GLB_EARNINGS_BALANCE_GROUP |
| LEGISLATION_CODE | null |
| LEGISLATIVE_DATA_GROUP_ID | null |
| BALANCE_CATEGORY_ATT_FLAG | null |
| BALANCE_DIMENSION_ATT_FLAG | null |

PAY_BAL_GRP_INCLUSIONS

| Column Name | Description |
|---|---|
| BAL_GRP_INCLUSION_ID | generated primary key |
| BALANCE_GROUP_ID | foreign key to GLB_EARNINGS_BALANCE_GROUP |
| ATTRIBUTE_ID | foreign key to pay_bal_att_definitions |
| LEGISLATION_CODE | null |
| LEGISLATIVE_DATA_GROUP_ID | null |

PAY_BAL_ATT_DEFINITIONS

| Column Name | Description |
|---|---|
| ATTRIBUTE_ID | generated primary key |
| BASE_ATTRIBUTE_NAME | generated attribute name |
| ALTERABLE | Y |
| LEGISLATION_CODE | null |
| LEGISLATIVE_DATA_GROUP_ID | null |
| BALANCE_CATEGORY_ID | null |
| BALANCE_DIMENSION_ID | null |

PAY_BALANCE_ATTRIBUTES

| Column Name | Description |
|---|---|
| BALANCE_ATTRIBUTE_ID | generated primary key |
| ATTRIBUTE_ID | foreign key to |
| | pay_bal_att_definitions |
| DEFINED_BALANCE_ID | foreign key to a |
| | pay_defined_balance for US |
| LEGISLATION_CODE | US |
| LEGISLATIVE_DATA_GROUP_ID | null |

Repeated for each defined balance that's required in the balance group.

PAY_BAL_GRP_USAGES

| Column Name | Description |
|---|---|
| BAL_GRP_USAGE_ID | generated primary key |
| BASE_GROUP_USAGE_NAME | Earnings Statement of Earnings |
| LEGISLATION_CODE | null |
| LEGISLATIVE_DATA_GROUP_ID | null |
| BALANCE_REPORT_TYPE | SOE |
| BALANCE_GROUP_ID | foreign key to GLB_EARNINGS_BALANCE_GROUP |
| FORMAT_TYPE | TABLE |
| REPORT_SORT_TYPE_ID | foreign key to pay_report_sort_types Global Name Sort |

PAY_BAL_GRP_USAGE_ITEMS

No entries for table.

PAY_REPORT_SORT_TYPES

| Column Name | Description |
|---|---|
| REPORT_SORT_TYPE_ID | generated primary key |
| BASE_SORT_NAME | Global Name Sort |
| LEGISLATION_CODE | null |
| LEGISLATIVE_DATA_GROUP_ID | null |
| SORT_METHOD | Name |
| SORT_LEVEL | null |
| SORT_ORDER | ASC |

PAY_REPORT_SORT_ITEMS

No entries for table.

Balance Group with Format Type Matrix (First Example)

Example definition of a balance group created by an end-user that's used primarily in the balance views screen to display balances that are regularly viewed. Format Type is Matrix, so pay_bal_grp_usage_items can be populated.

PAY_BALANCE_GROUPS

| Column Name | Description |
|---|---|
| BALANCE_GROUP_ID | generated primary key |
| BASE_GROUP_NAME | Balances Regularly |
| | Viewed BG |
| LEGISLATION_CODE | null |
| LEGISLATIVE_DATA_GROUP_ID | user ldg |
| BALANCE_CATEGORY_ATT_FLAG | null |
| BALANCE_DIMENSION_ATT_FLAG | null |

PAY_BAL_GRP_INCLUSIONS

| Column Name | Description |
|---|---|
| BAL_GRP_INCLUSION_ID | generated primary key |
| BALANCE_GROUP_ID | foreign key to Balances |
| | Regularly Viewed BG |
| ATTRIBUTE_ID | foreign key to |
| | pay_bal_att_definitions |
| LEGISLATION_CODE | null |
| LEGISLATIVE_DATA_GROUP_ID | user ldg |

PAY_BAL_ATT_DEFINITIONS

| Column Name | Description |
|---|---|
| ATTRIBUTE_ID | generated primary key |
| BASE_ATTRIBUTE_NAME | generated attribute name |
| ALTERABLE | Y |
| LEGISLATION_CODE | null |
| LEGISLATIVE_DATA_GROUP_ID | user ldg |
| BALANCE_CATEGORY_ID | null |
| BALANCE_DIMENSION_ID | null |

PAY_BALANCE_ATTRIBUTES

| Column Name | Description |
|---|---|
| BALANCE_ATTRIBUTE_ID | generated primary key |
| ATTRIBUTE_ID | foreign key to |
| | pay_bal_att_definitions |
| DEFINED_BALANCE_ID | foreign key to a |
| | pay_defined_balance for user |
| LEGISLATION_CODE | null |
| LEGISLATIVE_DATA_GROUP_ID | user ldg |

Repeated for each user-defined balance that's required in the balance group.

PAY_BAL_GRP_USAGES

| Column Name | Description |
|---|---|
| BAL_GRP_USAGE_ID | generated primary key |
| BASE_GROUP_USAGE_NAME | Balance Views Balances |
| | Regularly Viewed BG |
| LEGISLATION_CODE | null |
| LEGISLATIVE_DATA_GROUP_ID | user ldg |
| BALANCE_REPORT_TYPE | GLB_BAL_VIEW |
| BALANCE_GROUP_ID | foreign key to Balances |
| | Regularly Viewed BG |
| FORMAT_TYPE | MATRIX |
| REPORT_SORT_TYPE_ID | foreign key to |
| | pay_report_sort_types |
| | user Name Sort |

PAY_BAL_GRP_USAGE_ITEMS

| Column Name | Description |
|---|---|
| BAL_GRP_USAGE_ITEM_ID | generated primary key |
| BAL_GRP_USAGE_ID | foreign key to |
| | pay_bal_grp_usages |
| LEGISLATION_CODE | null |
| LEGISLATIVE_DATA_GROUP_ID | user ldg |
| SOURCE_TYPE | BD |
| SOURCE_ID | foreign key to |
| | pay_balance_dimensions |
| POSITION | 1 |

Repeated for each balance dimension that's required to be displayed from the balance group.

PAY_REPORT_SORT_TYPES

| Column Name | Description |
|---|---|
| REPORT_SORT_TYPE_ID | generated primary key |
| BASE_SORT_NAME | user Name Sort |
| LEGISLATION_CODE | null |
| LEGISLATIVE_DATA_GROUP_ID | user ldg |
| SORT_METHOD | Name |
| SORT_LEVEL | null |
| SORT_ORDER | ASC |

Balance Group with Format Type Matrix (Second Example)

Example definition of a user-defined balance group that is used primarily in the balance views screen to display balances that are regularly viewed. This matrix example can have multiple occurrences of the usage_items, which demonstrates how balances can be removed from display. Only the MTD, QTD, and YTD dimensions from the balance group can be displayed. Format Type is Matrix, so pay_bal_grp_usage_items are populated.

PAY_BALANCE_GROUPS

| Column Name | Description |
|---|---|
| BALANCE_GROUP_ID | generated primary key |
| BASE_GROUP_NAME | Balances Regularly |
| | Viewed WO Dims BG |
| LEGISLATION_CODE | null |
| LEGISLATIVE_DATA_GROUP_ID | user ldg |
| BALANCE_CATEGORY_ATT_FLAG | null |
| BALANCE_DIMENSION_ATT_FLAG | null |

PAY_BAL_GRP_INCLUSIONS

| Column Name | Description |
|---|---|
| BAL_GRP_INCLUSION_ID | generated primary key |
| BALANCE_GROUP_ID | foreign key to Balances |
| | Regularly Viewed WO |
| | Dims BG |
| ATTRIBUTE_ID | foreign key to |
| | pay_bal_att_definitions |
| LEGISLATION_CODE | null |
| LEGISLATIVE_DATA_GROUP_ID | user ldg |

PAY_BAL_ATT_DEFINITIONS

| Column Name | Description |
|---|---|
| ATTRIBUTE_ID | generated primary key |
| BASE_ATTRIBUTE_NAME | generated attribute name |
| ALTERABLE | Y |
| LEGISLATION_CODE | null |
| LEGISLATIVE_DATA_GROUP_ID | user ldg |
| BALANCE_CATEGORY_ID | null |
| BALANCE_DIMENSION_ID | null |

PAY_BALANCE_ATTRIBUTES

| Column Name | Description |
|---|---|
| BALANCE_ATTRIBUTE_ID | generated primary key |
| ATTRIBUTE_ID | foreign key to |
| | pay_bal_att_definitions |
| DEFINED_BALANCE_ID | foreign key to a |
| | pay_defined_balance |
| | for user ldg |
| LEGISLATION_CODE | null |
| LEGISLATIVE_DATA_GROUP_ID | user ldg |

Repeated for each user-defined balance that's required in the balance group.

PAY_BAL_GRP_USAGES

| Column Name | Description |
|---|---|
| BAL_GRP_USAGE_ID | generated primary key |
| BASE_GROUP_USAGE_NAME | Balance Views Balances |
| | Regularly Viewed WO Dims |
| | BG |
| LEGISLATION_CODE | null |
| LEGISLATIVE_DATA_GROUP_ID | user ldg |
| BALANCE_REPORT_TYPE | GLB_BAL_VIEW |
| BALANCE_GROUP_ID | foreign key to Balances |
| | Regularly Viewed WO Dims |
| | BG |
| FORMAT_TYPE | MATRIX |
| REPORT_SORT_TYPE_ID | foreign key to |
| | pay_report_sort_types |
| | user Name Sort |

PAY_BAL_GRP_USAGE_ITEMS

| Column Name | Description |
|---|---|
| BAL_GRP_USAGE_ITEM_ID | generated primary key |
| BAL_GRP_USAGE_ID | foreign key to |
| | pay_bal_grp_usages |
| LEGISLATION_CODE | null |
| LEGISLATIVE_DATA_GROUP_ID | user ldg |
| SOURCE_TYPE | BD |
| SOURCE_ID | foreign key to |
| | pay_balance_dimensions |
| | for MTD |
| POSITION | 1 |
| BAL_GRP_USAGE_ITEM_ID | generated primary key |
| BAL_GRP_USAGE_ID | foreign key to |
| | pay_bal_grp_usages |
| LEGISLATION_CODE | null |
| LEGISLATIVE_DATA_GROUP_ID | user ldg |
| SOURCE_TYPE | BD |
| SOURCE_ID | foreign key to |
| | pay_balance_dimensions |
| | for QTD |
| POSITION | 2 |
| BAL_GRP_USAGE_ITEM_ID | generated primary key |
| BAL_GRP_USAGE_ID | foreign key to |
| | pay_bal_grp_usages |
| LEGISLATION_CODE | null |
| LEGISLATIVE_DATA_GROUP_ID | user ldg |
| SOURCE_TYPE | BD |
| SOURCE_ID | foreign key to |
| | pay_balance_dimensions |
| | for YTD |
| POSITION | 3 |

PAY_REPORT_SORT_TYPES

| Column Name | Description |
|---|---|
| REPORT_SORT_TYPE_ID | generated primary key |
| BASE_SORT_NAME | user Name Sort |
| LEGISLATION_CODE | null |
| LEGISLATIVE_DATA_GROUP_ID | user ldg |
| SORT_METHOD | Name |
| SORT_LEVEL | null |
| SORT_ORDER | ASC |

PAY_REPORT_SORT_ITEMS

No entries for table.

### Adding Localization Balances to a Global Balance Group

Example definition of a localization adding balances to a global balance group (Earnings Balance Group that's used on the Statement-of-Earnings screen).

PAY_BALANCE_GROUPS

| Column Name | Description |
|---|---|
| BALANCE_GROUP_ID | generated primary key |
| BASE_GROUP_NAME | GLB_EARNINGS_BALANCE_GROUP |
| LEGISLATION_CODE | null |
| LEGISLATIVE_DATA_GROUP_ID | null |
| BALANCE_CATEGORY_ATT_FLAG | null |
| BALANCE_DIMENSION_ATT_FLAG | null |

PAY_BAL_GRP_INCLUSIONS

| Column Name | Description |
|---|---|
| BAL_GRP_INCLUSION_ID | generated primary key |
| BALANCE_GROUP_ID | foreign key to GLB_EARNINGS_BALANCE_GROUP |
| ATTRIBUTE_ID | foreign key to pay_bal_att_definitions |
| LEGISLATION_CODE | null |
| LEGISLATIVE_DATA_GROUP_ID | null |

PAY_BAL_ATT_DEFINITIONS

| Column Name | Description |
|---|---|
| ATTRIBUTE_ID | generated primary key |
| BASE_ATTRIBUTE_NAME | generated attribute name |
| ALTERABLE | Y |
| LEGISLATION_CODE | null |
| LEGISLATIVE_DATA_GROUP_ID | null |
| BALANCE_CATEGORY_ID | null |
| BALANCE_DIMENSION_ID | null |

PAY_BALANCE_ATTRIBUTES

| Column Name | Description |
|---|---|
| BALANCE_ATTRIBUTE_ID | generated primary key |
| ATTRIBUTE_ID | foreign key to |
| | pay_bal_att_definitions |
| DEFINED_BALANCE_ID | foreign key to |
| | a pay_defined_balance for CN |
| LEGISLATION_CODE | CN |
| LEGISLATIVE_DATA_GROUP_ID | null |

Repeated for each CN defined balance that's required in the balance group.

PAY_BAL_GRP_USAGES

| Column Name | Description |
|---|---|
| BAL_GRP_USAGE_ID | generated primary key |
| BASE_GROUP_USAGE_NAME | Earnings Statement of Earnings |
| LEGISLATION_CODE | null |
| LEGISLATIVE_DATA_GROUP_ID | null |
| BALANCE_REPORT_TYPE | SOE |
| BALANCE_GROUP_ID | foreign key to GLB_EARNINGS_BALANCE_GROUP |
| FORMAT_TYPE | MATRIX |
| REPORT_SORT_TYPE_ID | foreign key to pay_report_sort_types Global Name Sort |

PAY_BAL_GRP_USAGE_ITEMS

| Column Name | Description |
|---|---|
| BAL_GRP_USAGE_ITEM_ID | generated primary key |
| BAL_GRP_USAGE_ID | foreign key to |
| | pay_bal_grp_usages |
| LEGISLATION_CODE | CN |
| LEGISLATIVE_DATA_GROUP_ID | null |
| SOURCE_TYPE | BD |
| SOURCE_ID | foreign key to |
| | pay_balance_dimensions |
| | for ASG_TU_MTD |
| POSITION | 1 |
| BAL_GRP_USAGE_ITEM_ID | generated primary key |
| BAL_GRP_USAGE_ID | foreign key to |
| | pay_bal_grp_usages |
| LEGISLATION_CODE | CN |
| LEGISLATIVE_DATA_GROUP_ID | null |
| SOURCE_TYPE | BD |
| SOURCE_ID | foreign key to |
| | pay_balance_dimensions |
| | for ASG_TU_YTD |
| POSITION | 2 |

Repeated for each balance dimension that's required to be displayed from the balance group.

PAY_REPORT_SORT_TYPES

| Column Name | Description |
|---|---|
| REPORT_SORT_TYPE_ID | generated primary key |
| BASE_SORT_NAME | Global Name Sort |
| LEGISLATION_CODE | null |
| LEGISLATIVE_DATA_GROUP_ID | null |
| SORT_METHOD | Name |
| SORT_LEVEL | null |
| SORT_ORDER | ASC |

PAY_REPORT_SORT_ITEMS

No entries for table.

### Add User Balances to a Global Balance Group

The data is stored in a similar manner to that when adding localization balances to a balance group, except that localization_code will be null and legislative_data_group_id will be populated. In comparison to the add localization balances to a global balance group example above, all other data is the same.

### Balance Group With Sort Method Static (First Example)

Example of balance group with a sort method of static, sort on balance type. In this example, the earnings balance group is used with a user-defined usage, and assumes the usages are for user balances. Only the tables that are relevant to the sort example are included (and thus, other tables would be similar).

PAY_BAL_GRP_USAGES

| Column Name | Description |
|---|---|
| BAL_GRP_USAGE_ID | generated primary key |
| BASE_GROUP_USAGE_NAME | user Earnings Usage |
| LEGISLATION_CODE | null |
| LEGISLATIVE_DATA_GROUP_ID | user ldg |
| BALANCE_REPORT_TYPE | CUST_REPORT1 |
| BALANCE_GROUP_ID | foreign key to GLB_EARNINGS_BALANCE_GROUP |
| FORMAT_TYPE | MATRIX |
| REPORT_SORT_TYPE_ID | foreign key to pay_report_sort_types Cust BT Sort |

PAY_REPORT_SORT_TYPES

| Column Name | Description |
|---|---|
| REPORT_SORT_TYPE_ID | generated primary key |
| BASE_SORT_NAME | Cust BT Sort |
| LEGISLATION_CODE | null |
| LEGISLATIVE_DATA_GROUP_ID | user ldg |
| SORT_METHOD | Static |
| SORT_LEVEL | BT |
| SORT_ORDER | ASC |

PAY_REPORT_SORT_ITEMS

| Column Name | Description |
|---|---|
| REPORT_SORT_ITEM_ID | generated primary key |
| REPORT_SORT_TYPE_ID | foreign key to Cust BT Sort |
| LEGISLATION_CODE | null |
| LEGISLATIVE_DATA_GROUP_ID | user ldg |
| SEQUENCE_NUM | 1 |
| SOURCE_ID | foreign key to |
| | pay_balance_types for |
| | Balance 1 |
| REPORT_SORT_ITEM_ID | generated primary key |
| REPORT_SORT_TYPE_ID | foreign key to Cust BT Sort |
| LEGISLATION_CODE | null |
| LEGISLATIVE_DATA_GROUP_ID | user ldg |
| SEQUENCE_NUM | 2 |
| SOURCE_ID | foreign key to |
| | pay_balance_types for |
| | Balance 2 |
| REPORT_SORT_ITEM_ID | generated primary key |
| REPORT_SORT_TYPE_ID | foreign key to Cust BT Sort |
| LEGISLATION_CODE | null |
| LEGISLATIVE_DATA_GROUP_ID | user ldg |
| SEQUENCE_NUM | 3 |
| SOURCE_ID | foreign key to |
| | pay_balance_types for |
| | Balance 3 |

### Balance Group With Sort Method Static (Second Example)

Example of balance group with a sort method of static, sort on defined balance. In this example, the earnings balance group is used with a localization-defined usage, and assumes US balances (only includes the tables that are relevant to the sort example).

PAY_BAL_GRP_USAGES

| Column Name | Description |
|---|---|
| BAL_GRP_USAGE_ID | generated primary key |
| BASE_GROUP_USAGE_NAME | Tax Balance Summary for Employee |
| LEGISLATION_CODE | US |
| LEGISLATIVE_DATA_GROUP_ID | null |
| BALANCE_REPORT_TYPE | US_TAX_BAL_SUMMARY |
| BALANCE_GROUP_ID | foreign key to |
| | US_TAX_SUMMARY_EMPLOYEE_BALANCE_GROUP |
| FORMAT_TYPE | MATRIX |
| REPORT_SORT_TYPE_ID | foreign key to pay_report_sort_types US DB Sort |

PAY_REPORT_SORT_TYPES

| Column Name | Description |
|---|---|
| REPORT_SORT_TYPE_ID | generated primary key |
| BASE_SORT_NAME | US DB Sort |
| LEGISLATION_CODE | US |
| LEGISLATIVE_DATA_GROUP_ID | null |
| SORT_METHOD | Static |
| SORT_LEVEL | DB |
| SORT_ORDER | ASC |

PAY_REPORT_SORT_ITEMS

| Column Name | Description |
|---|---|
| REPORT_SORT_ITEM_ID | generated primary key |
| REPORT_SORT_TYPE_ID | foreign key to US DB Sort |
| LEGISLATION_CODE | US |
| LEGISLATIVE_DATA_GROUP_ID | null |
| SEQUENCE_NUM | 2 |
| SOURCE_ID | foreign key to |
| | pay_defined_balances |
| | for defined balance 2 |
| REPORT_SORT_ITEM_ID | generated primary key |
| REPORT_SORT_TYPE_ID | foreign key to US DB Sort |
| LEGISLATION_CODE | US |
| LEGISLATIVE_DATA_GROUP_ID | null |
| SEQUENCE_NUM | 3 |
| SOURCE_ID | foreign key to |
| | pay_defined_balances |
| | for defined balance 3 |

Balance Group with Multiple Usages

If a balance group is used in multiple places (e.g., statement-of-earnings, different reports, other screens, and so on), a separate pay_bal_grp_usages is created for each different usage of the balance group. If the usage is defined by a localization (e.g., a localization report using a global balance group) the legislation code is populated.

Balance Group with Category Flag

Example of a global balance group with the balance category flag set, assuming US balances. The pay_bal_grp_usages and associated tables are not relevant to this example, and so have been excluded.

PAY_BALANCE_GROUPS

| Column Name | Description |
|---|---|
| BALANCE_GROUP_ID | generated primary key |
| BASE_GROUP_NAME | GLB_TAX_DEDUCTIONS_BALANCE_GROUP |
| LEGISLATION_CODE | null |
| LEGISLATIVE_DATA_GROUP_ID | null |
| BALANCE_CATEGORY_ATT_FLAG | Y |
| BALANCE_DIMENSION_ATT_FLAG | null |

PAY_BAL_GRP_INCLUSIONS

| Column Name | Description |
|---|---|
| BAL_GRP_INCLUSION_ID | generated primary key |
| BALANCE_GROUP_ID | foreign key to GLB_TAX_DEDUCTIONS_BALANCE_GROUP |
| ATTRIBUTE_ID | foreign key to GLB_TAX_DEDUCTIONS_ATTRIBUTE |
| LEGISLATION_CODE | null |
| LEGISLATIVE_DATA_GROUP_ID | null |

PAY_BAL_ATT_DEFINITIONS

| Column Name | Description |
|---|---|
| ATTRIBUTE_ID | generated primary key |
| BASE_ATTRIBUTE_NAME | GLB_TAX_DEDUCTIONS_ATTRIBUTE |
| ALTERABLE | Y |
| LEGISLATION_CODE | null |
| LEGISLATIVE_DATA_GROUP_ID | null |
| BALANCE_CATEGORY_ID | foreign key to balance category Tax Deductions |
| BALANCE_DIMENSION_ID | null |

PAY_BALANCE_ATTRIBUTES

| Column Name | Description |
|---|---|
| BALANCE_ATTRIBUTE_ID | generated primary key |
| ATTRIBUTE_ID | foreign key to GLB_TAX_DEDUCTIONS_ATTRIBUTE |
| DEFINED_BALANCE_ID | foreign key to a pay_defined_balance for US |
| LEGISLATION_CODE | US |
| LEGISLATIVE_DATA_GROUP_ID | null |

Repeated for each US defined balance that's required in the balance group. It will be noted that the defined balances have a balance category of Tax Deductions.

Balance Group with Dimension Flag

Example of a balance group with the balance dimension flag set, assuming CN balance group and CN balances. It will be noted that the pay_bal_grp_usages and associated tables are not relevant to this example, and so have been excluded.

PAY_BALANCE_GROUPS

| Column Name | Description |
|---|---|
| BALANCE_GROUP_ID | generated primary key |
| BASE_GROUP_NAME | CN_REPORT_BALANCE_GROUP |
| LEGISLATION_CODE | CN |
| LEGISLATIVE_DATA_GROUP_ID | null |
| BALANCE_CATEGORY_ATT_FLAG | null |
| BALANCE_DIMENSION_ATT_FLAG | Y |

PAY_BAL_GRP_INCLUSIONS

| Column Name | Description |
|---|---|
| BAL_GRP_INCLUSION_ID | generated primary key |
| BALANCE_GROUP_ID | foreign key to CN_REPORT_BALANCE_GROUP |
| ATTRIBUTE_ID | foreign key to CN_REPORT_ASG_MTD_ATTRIBUTE |
| LEGISLATION_CODE | CN |
| LEGISLATIVE_DATA_GROUP_ID | null |

PAY_BAL_ATT_DEFINITIONS

| Column Name | Description |
|---|---|
| ATTRIBUTE_ID | generated primary key |
| BASE_ATTRIBUTE_NAME | CN_REPORT_ASG_MTD_ATTRIBUTE |
| ALTERABLE | Y |
| LEGISLATION_CODE | CN |
| LEGISLATIVE_DATA_GROUP_ID | null |
| BALANCE_CATEGORY_ID | null |
| BALANCE_DIMENSION_ID | foreign key to balance dimension _ASG_MTD |

PAY_BALANCE_ATTRIBUTES

| Column Name | Description |
|---|---|
| BALANCE_ATTRIBUTE_ID | generated primary key |
| ATTRIBUTE_ID | foreign key to CN_REPORT_ASG_MTD_ATTRIBUTE |
| DEFINED_BALANCE_ID | foreign key to a pay_defined_balance for CN |
| LEGISLATION_CODE | CN |
| LEGISLATIVE_DATA_GROUP_ID | null |

Repeated for each CN defined balance that's required in the balance group. It will be noted that the defined balances have a balance dimension of _ASG_MTD.

PAY_BAL_GRP_INCLUSIONS

| Column Name | Description |
|---|---|
| BAL_GRP_INCLUSION_ID | generated primary key |
| BALANCE_GROUP_ID | foreign key to CN_REPORT_BALANCE_GROUP |
| ATTRIBUTE_ID | foreign key to CN_REPORT_ASG_YTD_ATTRIBUTE |
| LEGISLATION_CODE | CN |
| LEGISLATIVE_DATA_GROUP_ID | null |

PAY_BAL_ATT_DEFINITIONS

| Column Name | Description |
|---|---|
| ATTRIBUTE_ID | generated primary key |
| BASE_ATTRIBUTE_NAME | CN_REPORT_ASG_YTD_ATTRIBUTE |
| ALTERABLE | Y |
| LEGISLATION_CODE | CN |
| LEGISLATIVE_DATA_GROUP_ID | null |
| BALANCE_CATEGORY_ID | null |
| BALANCE_DIMENSION_ID | foreign key to balance dimension _ASG_YTD |

PAY_BALANCE_ATTRIBUTES

| Column Name | Description |
|---|---|
| BALANCE_ATTRIBUTE_ID | generated primary key |
| ATTRIBUTE_ID | foreign key to CN_REPORT_ASG_YTD_ATTRIBUTE |
| DEFINED_BALANCE_ID | foreign key to a pay_defined_balance for CN |
| LEGISLATION_CODE | CN |
| LEGISLATIVE_DATA_GROUP_ID | null |

Repeated for each CN defined balance that's required in the balance group. It will be noted that the defined balances have a balance dimension of _ASG_YTD.

Balance Group with Category and Dimension Flag

Example of a localization balance group with the category and balance dimension flags set, assuming CN balances. It will be noted that the pay_bal_grp_usages and associated tables aren't relevant to this example, and so have been excluded.

PAY_BALANCE_GROUPS

| Column Name | Description |
|---|---|
| BALANCE_GROUP_ID | generated primary key |
| BASE_GROUP_NAME | CN_REPORT_BALANCE_GROUP |
| LEGISLATION_CODE | CN |
| LEGISLATIVE_DATA_GROUP_ID | null |
| BALANCE_CATEGORY_ATT_FLAG | Y |
| BALANCE_DIMENSION_ATT_FLAG | Y |

PAY_BAL_GRP_INCLUSIONS

| Column Name | Description |
|---|---|
| BAL_GRP_INCLUSION_ID | generated primary key |
| BALANCE_GROUP_ID | foreign key to CN_REPORT_BALANCE_GROUP |
| ATTRIBUTE_ID | foreign key to CN_REPORT_RESTRICT1_ATTRIBUTE |
| LEGISLATION_CODE | CN |
| LEGISLATIVE_DATA_GROUP_ID | null |

PAY_BAL_ATT_DEFINITIONS

| Column Name | Description |
|---|---|
| ATTRIBUTE_ID | generated primary key |
| BASE_ATTRIBUTE_NAME | CN_REPORT_RESTRICT1_ATTRIBUTE |
| ALTERABLE | Y |
| LEGISLATION_CODE | CN |
| LEGISLATIVE_DATA_GROUP_ID | null |
| BALANCE_CATEGORY_ID | foreign key to balance category Tax Deductions |
| BALANCE_DIMENSION_ID | foreign key to balance dimension _ASG_MTD |

PAY_BALANCE_ATTRIBUTES

| Column Name | Description |
|---|---|
| BALANCE_ATTRIBUTE_ID | generated primary key |
| ATTRIBUTE_ID | foreign key to CN_REPORT_RESTRICT1_ATTRIBUTE |
| DEFINED_BALANCE_ID | foreign key to a pay_defined_balance for CN |
| LEGISLATION_CODE | CN |
| LEGISLATIVE_DATA_GROUP_ID | null |

Repeated for each CN defined balance that's required in the balance group. It will be noted that the defined balances have a balance category of Tax Deductions and a balance dimension of _ASG_MTD.

PAY_BAL_GRP_INCLUSIONS

| Column Name | Description |
|---|---|
| BAL_GRP_INCLUSION_ID | generated primary key |
| BALANCE_GROUP_ID | foreign key to CN_REPORT_BALANCE_GROUP |
| ATTRIBUTE_ID | foreign key to CN_REPORT_RESTRICT2_ATTRIBUTE |
| LEGISLATION_CODE | CN |
| LEGISLATIVE_DATA_GROUP_ID | null |

PAY_BAL_ATT_DEFINITIONS

| Column Name | Description |
|---|---|
| ATTRIBUTE_ID | generated primary key |
| BASE_ATTRIBUTE_NAME | CN_REPORT_RESTRICT2_ATTRIBUTE |
| ALTERABLE | Y |
| LEGISLATION_CODE | CN |
| LEGISLATIVE_DATA_GROUP_ID | null |
| BALANCE_CATEGORY_ID | foreign key to balance category Tax Deductions |
| BALANCE_DIMENSION_ID | foreign key to balance dimension _ASG_YTD |

PAY_BALANCE_ATTRIBUTES

| Column Name | Description |
|---|---|
| BALANCE_ATTRIBUTE_ID | generated primary key |
| ATTRIBUTE_ID | foreign key to CN_REPORT_RESTRICT2_ATTRIBUTE |
| DEFINED_BALANCE_ID | foreign key to a pay_defined_balance for CN |
| LEGISLATION_CODE | CN |
| LEGISLATIVE_DATA_GROUP_ID | null |

Repeated for each CN defined balance that's required in the balance group. It will be noted that the defined balances have a balance category of Tax Deductions and a balance dimension of _ASG_YTD.

### Defaulting a Balance to a Balance Group

Example of defaulting a balance to a balance group. In this scenario, when a defined balance is created (either through element templates wizard or balances UI) which has a balance category of earnings and dimensions _CORE_ASG_RUN or _CORE_ASG_YTD, it is automatically associated with global balance groups GLB_EARNINGS_BALANCE_GROUP and GLB_PAYROLL_ASSIGNMENT_EARNINGS_BALANCE_GROUP

PAY_BALANCE_DIMENSIONS

| Column Name | Description |
|---|---|
| BALANCE_DIMENSION_ID | generated primary key |
| BASE_DIMENSION_NAME | _CORE_ASG_RUN |
| DIMENSION_LEVEL | ASG |
| LEGISLATION_CODE | null |
| LEGISLATIVE_DATA_GROUP_ID | null |
| BALANCE_DIMENSION_ID | generated primary key |
| BASE_DIMENSION_NAME | _CORE_ASG_YTD |
| DIMENSION_LEVEL | ASG |
| LEGISLATION_CODE | null |
| LEGISLATIVE_DATA_GROUP_ID | null |

PAY_BALANCE_CATEGORIES_F

| Column Name | Description |
|---|---|
| BALANCE_CATEGORY_ID | generated primary key |
| BASE_CATEGORY_NAME | Earnings |
| LEGISLATION_CODE | null |
| LEGISLATIVE_DATA_GROUP_ID | null |

PAY_BAL_ATT_DEFAULTS

| Column Name | Description |
|---|---|
| BAL_ATTRIBUTE_DEFAULT_ID | generated primary key |
| BALANCE_CATEGORY_ID | foreign key to Earnings |
| BALANCE_DIMENSION_ID | foreign key to _CORE_ASG_RUN |
| ATTRIBUTE_ID | foreign key to GLB_EARNINGS_ATTRIBUTE. |
| | This attribute is associated with Balance Group |
| | GLB_EARNINGS_BALANCE_GROUP |
| LEGISLATION_CODE | null |
| LEGISLATIVE_DATA_GROUP_ID | null |
| BAL_ATTRIBUTE_DEFAULT_ID | generated primary key |
| BALANCE_CATEGORY_ID | foreign key to Earnings |
| BALANCE_DIMENSION_ID | foreign key to _CORE_ASG_YTD |
| ATTRIBUTE_ID | foreign key to GLB_EARNINGS_ATTRIBUTE. |
| | This attribute is associated with Balance Group |
| | GLB_EARNINGS_BALANCE_GROUP |
| LEGISLATION_CODE | null |
| LEGISLATIVE_DATA_GROUP_ID | null |
| BAL_ATTRIBUTE_DEFAULT_ID | generated primary key |
| BALANCE_CATEGORY_ID | foreign key to Earnings |
| BALANCE_DIMENSION_ID | foreign key to _CORE_ASG_RUN |
| ATTRIBUTE_ID | foreign key to |
| | GLB_PAYROLL_ASSIGNMENT_EARNINGS_ATTRIBUTE. |
| | This attribute is associated with Balance Group |
| | GLB_PAYROLL_ASSIGNMENT_EARNINGS_BALANCE_GROUP. |
| LEGISLATION_CODE | null |
| LEGISLATIVE_DATA_GROUP_ID | null |
| BAL_ATTRIBUTE_DEFAULT_ID | generated primary key |
| BALANCE_CATEGORY_ID | foreign key to Earnings |
| BALANCE_DIMENSION_ID | foreign key to _CORE_ASG_YTD |
| ATTRIBUTE_ID | foreign key to |
| | GLB_PAYROLL_ASSIGNMENT_EARNINGS_ATTRIBUTE. |
| | This attribute is associated with Balance Group |
| | GLB_PAYROLL_ASSIGNMENT_EARNINGS_BALANCE_GROUP. |
| LEGISLATION_CODE | null |
| LEGISLATIVE_DATA_GROUP_ID | null |

### Examples of Balance Group Operations Available via User UI

As noted in connection with FIG. 4 and its associated discussion, and as outlined in connection with FIGS. 6C, 7, 8, 9 and 10 and their associated discussions, an end-user can perform a number of balance group operations via, for example, via a UI such as payroll management UI 410 (and so, balance group views screen 411). Such operations include, for example:

1. Create Balance Group

2. Maintain Balance Group

3. Delete Balance Group

4. Copy Balance Group

5. Update Balance Group

6. Associate with Balance Group

7. Search Balance Group

8. Sort Balance Group

9. Alternate Balance Group(s)

10. Check Balance Group Balance Validity

11. View Balance Group

### Create New Balance Group

The ability to define a new balance group provides end-users with benefits that include a standard user interface for defining balance groups and a guided process for creating new balance groups for end-users. It will be appreciated that core payroll and localizations are able to create predefined balance groups, for example. These predefined balance groups can be associated with selected reports and user interfaces delivered with the system, such as a balance view window or Statement-of-Earnings.

An end-user is able to create user-defined balance groups that can then be associated with customized reports/UIs or with existing product reports/UIs. User-defined balance groups can be associated with existing product reports/UIs when an end-user has a particular need for creating a specific list of balances to view or be reported. For example, a payroll manager may wish to create a balance group to use with the balance view window, in order to assist in checking particular balances after a payroll run. These particular balances would be included as part of a balance group to assist in performing this task.

For such a create balance group user interface, a guided process is provided to ensure the end-user includes all appropriate components of a balance group. The main operations involved in creating a balance group in this manner include operations that have the end-user:
1. Provide a name for the balance group. When creating or copying a balance group, a meaningful name should be defined.
2. Select a format type for the balance group (e.g., one of matrix table or single table). More information on format types is provided in connection with FIG. 8 and its associated discussion, as well as earlier sections regarding balance group definitions and balance group table definitions, among other portions of the present disclosure. Depending upon the format type chosen, the end-user may be required to provide more information as to the desired organization of the balances. A single table format type implies that the values for a group of balance types are displayed for a single time period. For example:

| Balance Name | YTD |
|---|---|
| Salary | 17500.00 |
| Bonus | 2500.00 |
| Car Allowance | 1500.00 |
| Meal Allowance | 280.00 |

A matrix table format type implies that the values for a group of balance types are displayed for more than one time period over a number of columns. For example:

| Balance Name | Run | QTD | YTD |
|---|---|---|---|
| Salary | 1650.00 | 6900.00 | 17500.00 |
| Bonus | 250.00 | 1000.00 | 2500.00 |
| Car Allowance | 150.00 | 500.00 | 1500.00 |
| Meal Allowance | 20.00 | 90.00 | 280.00 |

3. Select the balance type(s) to include as part of the balance group. The end-user should be able to select the balance types from a list of balance types in the system, and should be able to perform a search to filter that list. A pattern referred to as a “Shuttle Pool Design Pattern” is suitable for displaying balance types and enabling end-users to select those that are required.
4. Specify the sequence or sort type required for displaying the balances. More information on sorting is provided in connection with FIGS. 8 and 9, as well as their associated discussions, as well as earlier sections regarding balance group functions, sort types and orders, and balance group table definitions, among other portions of the present disclosure. The “Shuttle Pool Design Pattern” also enables the reordering of the selected balance types. Selected balance types can be moved up, moved to the top, moved down, or moved down to the bottom of the selected list using the reorder buttons.
5. Select the time dimension(s) to be included in the balance group. Only time dimensions associated with the chosen balance types should be selectable. The available time dimensions can be displayed in a table (e.g., using a “Master/Detail Pattern”). A checkbox in the first column of the table allows the end-user to select the required time dimensions. The corresponding balance types are displayed in the detail region below, when the time dimension row is highlighted. This assists end-users in validating which time dimensions belong to which balance types.
6. Select the balance contexts to be included in the balance group. Only contexts associated with the chosen balance types and time dimensions are displayed. Similarly to time dimensions, the end-user is able to view the valid list of contexts for the balance types and time dimensions, and then select those required.
7. Associate the balance group with report/user interface/process. The end-user is able to select a predefined report/user interface/process name from a choice list. A balance group can be associated with more than one report/user interface/process, as a balance group can be reused for a number of different functions.
8. Associate the balance group with a particular end-user. The end-user is able to select a user name from the appropriate user table in the given schema. The user names can be displayed in a single select list box, for example.

### Maintain Balance Group

The ability to modify an existing balance group provides benefits such as a standard user interface for modifying balance groups (e.g., for end-users), as well as providing end-users with the ability to change balance groups, as required. An end-user is able to edit user-defined balance groups. Editing options include:
Adding or removing balance types. This may affect the time dimensions and balance contexts that have already been included in the balance group.
Changing the sequence or sort type required for displaying the balances.
Adding or removing the time dimension(s) to be included in the balance group. End-users should be limited to adding time dimensions that are associated with the chosen balance types. If balance types have been added, the end-user may have the option to include additional time dimensions associated with the new balance types. If balance types have been removed from the balance group then the end-user may find that there are time dimensions that are no longer available as they were associated with those removed balance types.
Adding or removing balance contexts to be included in the balance group. End-users are only able to add contexts that are associated with the chosen balance types and time dimensions. If balance types have been added then the end-user may have the option to include additional contexts associated with the new balance types. If balance types have been removed from the balance group then the end-user may find that there are contexts that are no longer available as they were associated with those removed balance types.
Associating the balance group with report/user interface/process.
Associating the balance group with a particular end-user.

It will be noted that the end-user interface requirements of the maintenance of balance groups is similar to the create balance group function. The end-user should be able to select a particular component of the balance group and make changes to that component only. However, it is important to note that the end-user may still need to be taken through a guided process to ensure that any changes that are made are reflected in the other parts of the balance groups. For example, if an end-user adds a balance type to a balance group, adding that balance type may provide the end-user the opportunity to include a time period that is associated with that balance type only, or include a context in the balance group that is associated with added balance type. The end-user is able to select the balance group to maintain from the balance group view described in view balance groups.

### Delete Balance Group

An end-user is able to delete only user-defined balance groups. The end-user should be provided with a review facility to allow them to see the contents of the given balance group and the UI/Reports that reference the given balance group, as well as the end-users that have been associated. After reviewing this information, the end-user can confirm whether they would like to proceed with the deletion. Preventing end-users from deleting predefined balance groups include the preservation of predefined information that is delivered by core payroll or localization, and ensuring that predefined balance groups used for statutory or regulatory reporting are not removed by end-users.

End-users are prevented from deleting predefined global and localization balance groups, preferably, at least because core payroll and localizations, which define global and localization balance groups for use in reports/user interfaces, are based on statutory and regulatory reporting. Therefore, the system should ensure that any such predefined balance groups are not removed by end-users. In certain implementations, predefined balance groups cannot be edited, which ensures that balance groups that are used for statutory/regulatory reporting are preserved and not changed by end-users. End-users can be excluded from editing any of the existing configurations related to the predefined global and localization balance groups. In addition, because core payroll and localization define global and localization balance groups for use in reports/user interfaces and statutory and regulatory reporting, only core payroll and localization can make changes to these predefined balance groups as required.

### Copy Balance Group

End-users and others can be provided with the ability to copy balance groups. The benefits of allowing balance groups to be copied include reduced effort for end-users (as such copying allows an existing balance group to be replicated, and then edited as required), as well as providing the end-user the ability to leverage off predefined balance groups for their own purposes. For example, balance groups can be predefined by core payroll or localization, as required. End-users can then create their own versions of these predefined balance groups by copying the given balance group(s) and editing them. The copied balance group should have a different name, as compared to the original predefined version. If an end-user copies a predefined balance group, the end-user is able to make changes to copied version of the predefined balance group, as required. Such editing options include those described with regard to maintaining balance groups.

An end-user can also copy a user-defined balance group and modify that, as required. As before, the end-user is required to change the name of the newly-copied balance group. Copying a balance group provides end-users with the flexibility to use the predefined balance groups for their own custom reports and user interfaces (though in so doing, the end-user becomes responsible for maintaining the balance group thus copied).

Update Balance Group from Element Template

The benefits of providing the ability for end-users to update balance groups from an element template include the ability to automatically maintain predefined balance groups provided by core payroll, and so avoid the need for such end-users to define their own balance groups. Additionally, providing end-users with the ability to update balance groups from an element template encourages reusability and consistency by providing for the ongoing maintenance of the global balance groups. Balance groups are maintained by having defined balances added to them when elements are created using the element template. Balances that are created as a result of the element definition can be added to the appropriate balance group.

Associate Report/UI with Balance Group

The benefits of providing the ability for end-users to associate a report and/or UI with a balance group include providing an end-user with the ability to identify from where a balance group is referenced. Further, providing end-users with the ability to associate a report and/or UI with a balance group encourages reusability and consistency by enabling multiple reports/user interfaces to reference the same global balance groups.

The association of a balance group (e.g., with a report, user interface or the like) defines where the balance group is to be referenced. End-users are able to associate the global, localization or user-defined balance groups with reports/user interfaces. For example, a global Earnings_Balance_Group may be associated with the Statement-of-Earnings. The end-user may also wish to use the same balance group with the payslip archiver and the balance view window. The aforementioned associate thus provides a mechanism for enabling a balance group to be associated with more than one report/user interface/process.

Additionally, a report/user interface can have more than one balance group associated with the report/user interface. For example, a Statement-of-Earnings may include a number of balance groups, including, for example, Earnings_Balance_Group, Tax_Deductions_Balance_Group, Voluntary_Deductions_Balance_Group and so on. With each association of the balance group with a report/user interface, a different sort or sequence can be defined. So, when an Earnings_Balance_Group is used with the Statement-of-Earnings, it may specified that the balances are displayed in balance value descending order. But when an Earnings_Balance_Group is used with the Balance View, it may be specified that the balances are displayed in balance type name ascending order. This ultimately provide greater flexibility in the display of balance information for end-users.

### Balance Group Search

The benefits of providing the ability for end-users to perform balance group searches include providing an end-user with the ability to locate information about a particular balance group. Further, providing end-users with the ability to perform balance group searches also enables end-users to find out detailed information about a Balance Group based upon some simple search criteria. Such a search facility provides end-users with information about which balance groups are used in particular reports/user interfaces and/or which end-users have ownership thereof.

In an implementation such as that depicted in FIG. 4 of the present disclosure, for example, an end-user is able to search based upon:
Balance Group Name
Balance Type Name
Report/User Interface/Process Name
User Name

In this case, a pattern referred to as a “Local Area Search Pattern” is required. All of the required search fields should be displayed as a single select list box. The results of the search are displayed in a pattern referred to as a “Tree Detail Pattern.” For more information about viewing balance groups please refer to View Balance Groups.

### View Balance Groups

The benefits of providing the ability for end-users to view balance groups include providing an end-user with the ability to view a given balance group and its components in a tree structure. Further, providing end-users with the ability to view balance groups also enables end-users to view basic information about a balance group as a result of a search.

The view balance function displays the balance groups using a “Tree Detail Pattern.” The end-user is able to view all balance groups listed in the tree hierarchy, view balance groups in the tree hierarchy that are the result of a search, or the like. Such a tree structure enables end-users to navigate through the hierarchy and view information about the components of a balance group in more detail in an adjacent detail pane. For example, if the end-user has navigated through the Global_Tax_Deductions_BG and expanded the balance type node they are able to see information about each of the balance types associated with this balance group in the detail pane. If the user selects the “Users” section, the user is able to see a list of users associated with this balance group in the detail pane.

The view balance group window should display the balance components in their simplest form (e.g., balance types, time dimensions, contexts and the like, rather than as defined balances). This view balance group functionality can be viewed as a springboard for other balance group actions. Thus, from this window, the end-user could choose to:
Search for a specific balance group.
View all balance groups.
Create a new balance group.
Maintain an existing balance group.
Copy an existing balance group.
Delete an existing balance group.

### Sorting Options for Balance Groups

The benefits of providing end-users with sorting options for balance groups include providing an end-user with multiple options for sequencing and sorting balances in a balance group. A key component to the definition of the balance group is the sequencing of the balances.

Sequencing options include:
Sort by balance type name in ascending or descending sequence.
Sort by balance value in ascending or descending sequence.
Static sequencing of balance types as ordered by the end-user.

For each report/user interface/process that the Balance Group is associated with, the end-user should be able to create separate sequencing options. For example, the Earnings_BG could be associated with the Balance View user interface, a Monthly Earnings Report and the Statement of Earnings. For each of these uses, a different sequencing may be required (i.e., if the Balance View user interface is to display the balances in balance value descending sequence, the Monthly Earnings Report sequenced by ascending balance type name and the Statement of Earnings sequence could be a static order defined by the end-user).

For the matrix table and single table format types, any of the sequence options listed above applies to all of the balances selected as part of the balance group. For the multiple table format type, the end-user is required to sequence the regions that they have specified and then sequence the balances within each of the regions. The same sequencing options listed above apply to sequencing the regions and the balances within the regions. If no sort options are specified by the end-user, the default is to by sort by balance type name in descending sequence.

### Provide Alternate Balance Group(s)

The benefits of providing end-users with alternate balance group(s) include providing localizations and end-users with alternative balance groups to those that are predefined as global balance groups. Preferably, a system according to embodiments of the present invention provides as many globally-predefined balance groups as possible, and in so doing, encourages localizations and end-users to reuse these pre-existing objects that already exist.

However, genuine cases in which a localization or end-user need to create their own version of a balance group exist. For example, the Global_Earnings_BG balance group is used to display earnings balances in the Statement-of-Earnings. The US localization may have additional earnings balance types that are specific to the US, which may also need to be displayed. And, just as a localization may have this need, certain end-users may also encounter such needs (especially with the provision of user-defined dimensions and contexts). To this end, a facility to create an alternative balance group to the global predefined one, preferably as part of the balance group UI, is provided, and includes a local alternative balance group and a user alternative balance group. It is also important to define that the alternative balance group (at the localization or user level) is related to the global balance group. It should be appreciated that this is distinct from the copy balance group function, in which there is no relationship or link maintained between the original and copied balance groups. Thus, a global balance group is envisaged, as is the potential for alternatives at the localization and end-user levels. The ability to maintain that for some outputs is also provided, when not using the alternative balance group(s). For example, in one scenario, a payment summary is the legislative end-of-year tax summary produced for employees. An end-of-year archive balance group can be used to retrieve the balance values required for this reporting. Even though an end-user may create an alternative balance group, the payment summary would still only use the end-of-year archive balance group. In such a scenario, there needs to be an indicator to denote whether overrides for the associated balance groups are allowed for certain reports/user interfaces/processes.

### Multiple Table Format Type

The benefits of providing a multiple table format type include providing an end-user with the ability to have an additional method of formatting balance results. The multiple table format type requires additional input from the end-user, including specifying the number of display regions required and which balance types are to be displayed in each region.

For example, a multiple table format type can be displayed in the following manner.

| | Run | YTD |
|---|---|---|
| Gross Earnings Region | | |
| Salary | 1650.00 | 17500.00 |
| Bonus | 250.00 | 2500.00 |
| Car Allowance | 150.00 | 1500.00 |
| Meal Allowance | 20.00 | 280.00 |
| Tax Deduction Region | | |
| Federal Tax | 250.00 | 1800.00 |
| State Tax (CA) | 150.00 | 900.00 |
| City Tax (LA) | 100.00 | 500.00 |
| Vol. Deduction Region | | |
| Superannuation | 100.00 | 500.00 |
| Charity Contribution | 20.00 | 100.00 |

### Extend Predefined Balance Groups

The benefits of providing the ability for end-users to extend predefined balance groups include providing an end-user with the ability to extend the information associated with a predefined balance group. Preferably, a system according to embodiments of the present invention provides as many globally-predefined balance groups as possible, and in so doing, encourages localizations and end-users to reuse these pre-existing objects that already exist. However, with the introduction of user-defined dimensions and contexts, there are likely to be cases in which an end-user would like to include these additional user-defined components with a predefined balance group.

Providing extension functionality to balance groups enables end-users to do this. They would have the ability to include additional balance types, time periods and contexts. Balance Group extensions could be provided at the localization and user levels. Ideally, it is an appropriate extension solution for end-users as the integrity of the global predefined balance group is maintained. There is also the ability to exclude balances from a balance group, if for some reason the balance was not required. There may be balance information that has been added to a predefined balance group via the integration with the element template. If an end-user does not necessarily require all of the balance information from a balance group to be displayed in a user-defined report, giving the end-user the ability to include or exclude certain balance components based on the usage of that balance group greatly enhances the use of balance groups.

Associate a Role with Balance Group

The benefits of providing the ability for end-users to associate a role with a balance group include providing an end-user with the ability to define their own balance groups for use with a specific role. Further, providing end-users with the ability to associate a role with a balance group also allows an end-user to associate a balance group with one or more roles, such that such users have a default balance group to use by default (e.g., for Balance View UI).

End-users also need the ability to associate a balance group with multiple roles. When an end-user runs a specific report or displays a specific user interface, the end-user sees balances from a balance group particular to their requirements. For example, there could be a payroll user in a payroll office whose main task is to check balance values after a payroll run is processed. A payroll manager (or payroll specialist) may define a balance group for the payroll clerk role so that when the clerk opens the balance view window, the clerk sees specific balance values to assist in checking the payroll run. In such a scenario, the end-user is able to define balance groups for their own role and/or associate with other roles (provided that the role was able to perform this function). The end-user creating or updating the balance group should only be able to associate the balance group with their role or roles that are lower level roles than their own. Users can also search one or more balance group(s) based upon role name.

Check Validity of Balances

The benefits of providing the ability for end-users to check the validity of balances include keeping end-users better informed about potential performance issues when submitting of reports that retrieve balances. Further, providing end-users with the ability to check the validity of balances also provides end-users with a status of balances before they perform any balance validation processes. Users may also need the option to check the status of balances associated with the balance group, and the date from which the balance would be valid.

A balance group can have a number of balances associated therewith. For the purposes of optimizing performance, it is important to determine the status of the balances. If the balances are not valid for the period that the reports/user interfaces being rendered, the performance can slow, and thus, enabling end-users to determine the status of balances prior to running reports or viewing balances assist the end-users in managing when a run balance validation process needs to be submitted. Balance checking (i.e., checking the validity of balances) is not intended to be within the scope of the balance group UI. Core payroll provides functionality to check the validity of balances, and then to perform the validation.

### Examples of Use Cases for Balance Groups

TABLE 6
Create New Balance Group Use Case.

| | |
|---|---|
| Use Case Title | Create Balance Group |
| Related BPM Task | Maintain Payroll Business Definition |

Roles

| Role Name | Importance to Role |
|---|---|
| Payroll Manager/Payroll | Central to Role |
| Specialist | Facilitates Role |
| Task Type | Professional: designed for occasional use, mostly related to |
| | transaction processing |
| Setup Prerequisites | Functional security determine which users are able to perform this |
| | task |
| Primary Scenario | User has created a custom report PAY DETAILS REPORT. They |
| | wish to create a Balance Group to group the balances required for |
| | this report and sequence these balances as they should appear on the |
| | report. |
| | User creates a new Balance Group - |
| | PAY_DETAILS_REPORT_BG. |
| | Select a format type of Matrix Table for the Balance Group. |
| | User associates the Balance types they require with the balance |
| | group. |
| | They select the MTD, QTD and YTD time periods to include in the |
| | balance group. |
| | They select the TRU context to include with the balance group. |
| | User then associates this new Balance Group with the report PAY |
| | DETAILS REPORT. |
| | The user then chooses the sequence in which these balances are to be |
| | displayed in the report. |
| | The user then saves the PAY_DETAILS_REPORT_BG. |
| Error Scenarios | The user may attempt to enter unacceptable data in a field. When |
| | they try to leave the field or save the record, they should get a popup |
| | message describing the error and the associated rules (minimum, |
| | maximum, formula name, and so on). If a list of values or table is |
| | available, the user should be directed to query the list. The user may |
| | attempt to submit a change without completing all required fields |
| | correctly. If so, the system should provide a message and identify |
| | the fields with missing or incorrect data. |

TABLE 7
Associate Balance Group with Report Use Case.

| | |
|---|---|
| Use Case Title | Associate Balance Group |
| Related BPM Task | Maintain Payroll Business Definition |

Roles

| Role Name | Importance to Role |
|---|---|
| Payroll Manager/Payroll | Central to Role |
| Specialist | Facilitates Role |
| Task Type | Professional: designed for occasional use, mostly related to |
| | transaction processing |
| Recommended for | Test/Documentation/Demo (include comments) |
| Setup Prerequisites | Functional security determine which users are able to perform this |
| | task |
| Primary Scenario | A user may have another report PAYROLL INFORMATION |
| | REPORT that they would want to reference the same balances |
| | included in the previously defined balance group. |
| | User searches for the PAY_DETAILS_REPORT_BG balance group |
| | in the View Balance Group window. |
| | The user select to maintain this balance group and choose the User |
| | information. |
| | User then associates this Balance Group with the report PAY |
| | INFORMATION REPORT. |
| | The user then saves the PAY_DETAILS_REPORT_BG. |
| Error Scenarios | The user may attempt to enter unacceptable data in a field. When |
| | they try to leave the field or save the record, they should get a popup |
| | message describing the error and the associated rules (minimum, |
| | maximum, formula name, and so on). If a list of values or table is |
| | available, the user should be directed to query the list. |
| | The user may attempt to submit a change without completing all |
| | required fields correctly. If so, the system should provide a message |
| | and identify the fields with missing or incorrect data. |

TABLE 8
Copy Predefined Balance Group Use Case.

| | |
|---|---|
| Use Case Title | Copy Predefined Balance Group |
| Related BPM Task | Maintain Payroll Business Definition |

Roles

| Role Name | Importance to Role |
|---|---|
| Payroll Manager/Payroll | Central to Role |
| Specialist | Facilitates Role |
| Task Type | Professional: designed for frequent use, mostly related to transaction |
| | processing |
| Recommended for | Test/Documentation/Demo (include comments) |
| Setup Prerequisites | Functional security determine which users are able to perform this |
| | task |
| Primary Scenario | User decides to change the seeded Balance Group for the Balance |
| | View window. They would like to define a specific set of balances |
| | to be displayed in a certain order when they open the Balance View |
| | window. |
| | They take a copy of the predefined BALANCE_VIEW_BG and save |
| | the copy as OUR_BALANCE_VIEW_BG. |
| | The format type for this Balance Group is Matrix Table. |
| | User selects to maintain the copied balance group. The user selects |
| | to add additional balance types that are to be included in the Balance |
| | View window. |
| | The user then choose the sequence in which the balances are to be |
| | displayed in the Balance View window. |
| | User then associates this new Balance Group with the BALANCE |
| | VIEW UI. |
| | The user then saves the OUR_BALANCE_VIEW_BG. |
| Error Scenarios | The user may attempt to enter unacceptable data in a field. When |
| | they try to leave the field or save the record, they should get a popup |
| | message describing the error and the associated rules (minimum, |
| | maximum, formula name, and so on). If a list of values or table is |
| | available, the user should be directed to query the list. |
| | The user may attempt to submit a change without completing all |
| | required fields correctly. If so, the system should provide a message |
| | and identify the fields with missing or incorrect data. |

TABLE 9
Create User-Defined Balance Group Use Case.

| | |
|---|---|
| Use Case Title | Create User-defined Balance Group |
| Related BPM Task | Maintain Payroll Business Definition |

Roles

| Role Name | Importance to Role |
|---|---|
| Payroll Manager/Payroll | Central to Role |
| Specialist | Facilitates Role |
| Task Type | Professional: designed for frequent use, mostly related to transaction |
| | processing |
| Recommended for | Test/Documentation/Demo (include comments) |
| Setup Prerequisites | Functional security determine which users are able to perform this |
| | task |
| Primary Scenario | The user has a tax report MONTHLY_TAX_REPORT that needs to |
| | display Federal, State and City taxes in three separate sections of the |
| | report. |
| | They create a new Balance Group MONTHLY_TAX_BG. |
| | The Multiple Tables format type is selected. |
| | They then select all of the tax balance types they require to be |
| | included in the balance group. They sequence the balance types in |
| | Federal, State and City tax sequence. |
| | They select the RUN and YTD time periods to be included. |
| | They select the TRU and JURISDICTION contexts to be included in |
| | the balance group. |
| | The Balance Group is then associated with the |
| | MONTHLY_TAX_REPORT report. |
| | The MONTHLY_TAX_BG Balance Group is saved. |
| Error Scenarios | The user may attempt to enter unacceptable data in a field. When |
| | they try to leave the field or save the record, they should get a popup |
| | message describing the error and the associated rules (minimum, |
| | maximum, formula name, and so on). If a list of values or table is |
| | available, the user should be directed to query the list. |
| | The user may attempt to submit a change without completing all |
| | required fields correctly. If so, the system should provide a message |
| | and identify the fields with missing or incorrect data. |

TABLE 10
Define Specific Balance Sequence Use Case.

| | |
|---|---|
| Use Case Title | Define Specific Balance Sequence |
| Related BPM Task | Maintain Payroll Business Definition |

Roles

| Role Name | Importance to Role |
|---|---|
| Payroll Manager/ | Central to Role |
| Payroll Specialist | Facilitates Role |
| Task Type | Professional: designed for occasional use, mostly related to transaction |
| | processing |
| Recommended for | Test/Documentation/Demo (include comments) |
| Setup Prerequisites | Functional security determine which users are able to perform this task |
| Primary Scenario | The US localization requires a Balance Group for the Balance View window |
| | so that specific tax balances are displayed. |
| | The FED_TAXES_BG, STATE_TAXES_BG and CITY_TAXES_BG |
| | balance groups are defined. |
| | The US_TAX_BAL_BG Balance Group is created as the parent balance |
| | group and the three new balance groups are associated with it as child |
| | balance groups. They are positioned in sequence: FED_TAXES_BG, |
| | STATE_TAXES_BG and CITY_TAXES_BG. |
| | The Multiple Tables format type is selected. |
| | The Static sort type is selected to enable the user to order the balances in the |
| | sequence they require. |
| | The balance types of the FED_TAXES_BG balance group are ordered as |
| | follows: Social Security, Medicare, Fit Withheld and then EIC Advance. |
| | The balances of the STATE_TAXES_BG balance group are ordered as |
| | follows: SUI, SDI, and Withheld. |
| | The balances of the CITY_TAXES_BG balance group are ordered as |
| | follows: Withheld and County. |
| | The US_TAX_BGL_BG Balance Group is saved. |
| | This parent Balance Group can then be selected by users in the Balance |
| | View window. It display the Federal tax balances first, the State tax |
| | balances and then the State and County tax balances follow. |
| | Alternatively, the users can select each of the child balance groups |
| | individually and view the information only associated with them. |
| Error Scenarios | The user may attempt to enter unacceptable data in a field. When they try to |
| | leave the field or save the record, they should get a popup message |
| | describing the error and the associated rules (minimum, maximum, formula |
| | name, and so on). If a list of values or table is available, the user should be |
| | directed to query the list. |
| | The user may attempt to submit a change without completing all required |
| | fields correctly. If so, the system should provide a message and identify the |
| | fields with missing or incorrect data. |

### An Example Computing and Network Environment

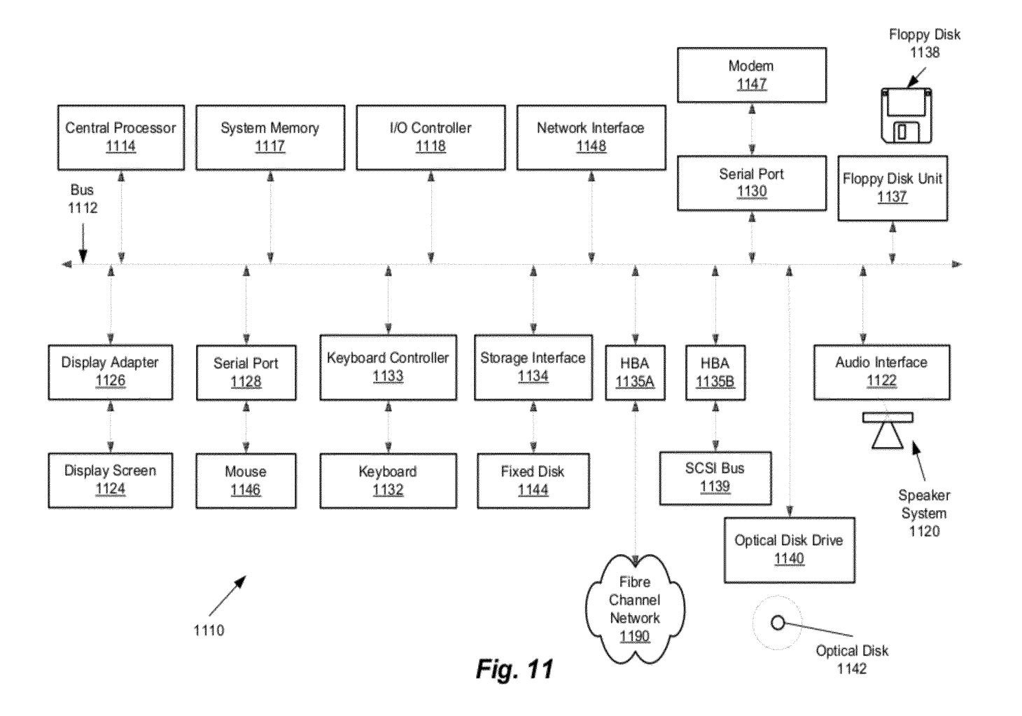

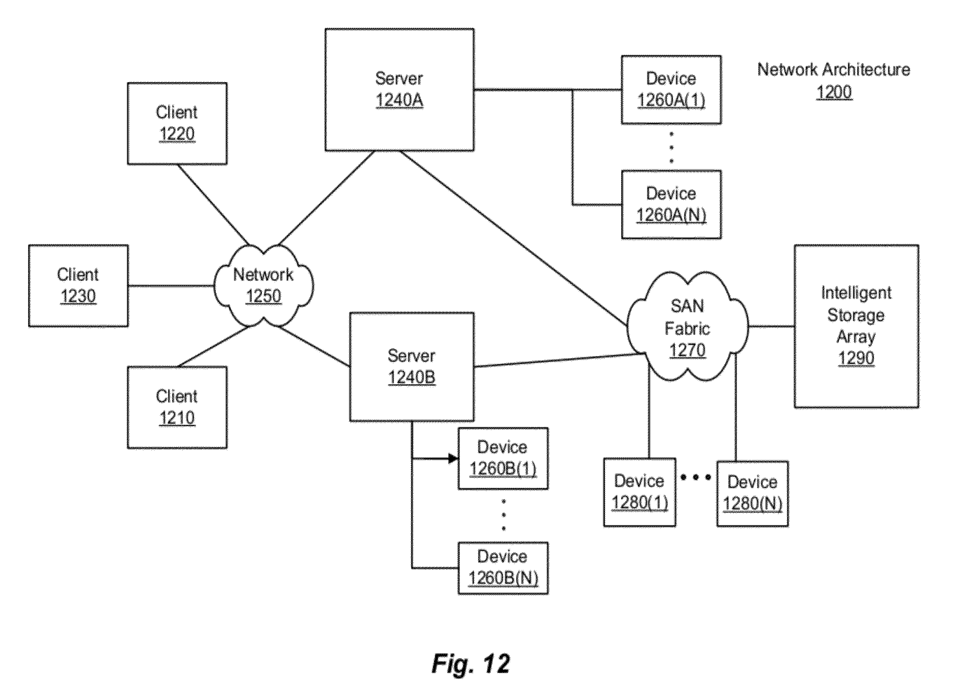

As shown above, the present invention can be implemented using a variety of computer systems and networks. An example of one such computing and network environment is described below with reference to FIGS. 11 and 12.

FIG. 11 depicts a block diagram of a computer system 1110 suitable for implementing aspects of the present invention (e.g., servers 620, gateway server 650, clients 660 and web clients 665). Computer system 1110 includes a bus 1112 which interconnects major subsystems of computer system 1110, such as a central processor 1114, a system memory 1117 (typically RAM, but which may also include ROM, flash RAM, or the like), an input/output controller 1118, an external audio device, such as a speaker system 1120 via an audio output interface 1122, an external device, such as a display screen 1124 via display adapter 1126, serial ports 1128 and 1130, a keyboard 1132 (interfaced with a keyboard controller 1133), a storage interface 1134, a floppy disk drive 1137 operative to receive a floppy disk 1138, a host bus adapter (HBA) interface card 1135A operative to connect with a Fibre Channel network 1190, a host bus adapter (HBA) interface card 1135B operative to connect to a SCSI bus 1139, and an optical disk drive 1140 operative to receive an optical disk 1142. Also included are a mouse 1146 (or other point-and-click device, coupled to bus 1112 via serial port 1128), a modem 1147 (coupled to bus 1112 via serial port 1130), and a network interface 1148 (coupled directly to bus 1112).

Bus 1112 allows data communication between central processor 1114 and system memory 1117, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with computer system 1110 are generally stored on and accessed via a computer-readable medium, such as a hard disk drive (e.g., fixed disk 1144), an optical drive (e.g., optical drive 1140), a floppy disk unit 1137, or other storage medium.

Storage interface 1134, as with the other storage interfaces of computer system 1110, can connect to a standard computer-readable medium for storage and/or retrieval of information, such as a fixed disk drive 1144. Fixed disk drive 1144 may be a part of computer system 1110 or may be separate and accessed through other interface systems. Modem 1147 may provide a direct connection to a remote server via a telephone link or to the Internet via an internet service provider (ISP). Network interface 1148 may provide a direct connection to a remote server via a direct network link to the Internet via a POP (point of presence). Network interface 1148 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 11 need not be present to practice the present invention. The devices and subsystems can be interconnected in different ways from that shown in FIG. 11. The operation of a computer system such as that shown in FIG. 11 is readily known in the art and is not discussed in detail in this application. Code to implement the present invention can be stored in computer-readable storage media such as one or more of system memory 1117, fixed disk 1144, optical disk 1142, or floppy disk 1138. The operating system provided on computer system 1110 may be MS-DOS®, MS-WINDOWS®, UNIX®, Linux®, or another known operating system.

Moreover, regarding the signals described herein, those skilled in the art recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present invention may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

FIG. 12 is a block diagram depicting a network architecture 1200 in which client systems 1210, 1220 and 1230, as well as storage servers 1240A and 1240B (any of which can be implemented using computer system 1210), are coupled to a network 1250. Storage server 1240A is further depicted as having storage devices 1260A(1)-(N) directly attached, and storage server 1240B is depicted with storage devices 1260B(1)-(N) directly attached. Storage servers 1240A and 1240B are also connected to a SAN fabric 1270, although connection to a storage area network is not required for operation of the invention. SAN fabric 1270 supports access to storage devices 1280(1)-(N) by storage servers 1240A and 1240B, and so by client systems 1110, 1120 and 1130 via network 1150. Intelligent storage array 1190 is also shown as an example of a specific storage device accessible via SAN fabric 1270.

With reference to computer system 1110, modem 1147, network interface 1148 or some other method can be used to provide connectivity from each of client computer systems 1210, 1220 and 1230 to network 1250. Client systems 1210, 1220 and 1230 are able to access information on storage server 1240A or 1240B using, for example, a web browser or other client software (not shown). Such a client allows client systems 1210, 1220 and 1230 to access data hosted by storage server 1240A or 1240B or one of storage devices 1260A(1)-(N), 1260B(1)-(N), 1280(1)-(N) or intelligent storage array 1290. FIG. 12 depicts the use of a network such as the Internet for exchanging data, but the present invention is not limited to the Internet or any particular network-based environment.

Although the invention has been described in connection with several embodiments, the invention is not intended to be limited to the specific forms set forth herein. On the contrary, it is intended to cover such alternatives, modifications, and equivalents as can be reasonably included within the scope of the invention as defined by the appended claims.

What is claimed is:

1. A computer implemented method comprising:
selecting one or more balance types for a balance group;
selecting time periods for which the balance group is to be effective;
selecting a context in which the balance group is to operation is selected after selecting the one or more balance types and time periods;
determining sort options are needed to support a functionality to be provided by the balance group; and
selecting a format type for the balance group, wherein the format type indicates the format in which defined balance information is organized when returned to a payroll application.

2. The method of claim 1 wherein the format type comprises a matrix table.

3. The method of claim 1 wherein the format type comprises a single table.

4. The method of claim 1 further comprising:
reviewing the balance group to ensure that information will be returned;
after reviewing the balance group to ensure that information will be returned, saving the balance group to a metadata repository.

5. A computer readable memory comprising executable instructions, wherein a method is implemented in response to executing the instructions, the method comprising:
selecting one or more balance types for a balance group;
selecting time periods for which the balance group is to be effective;
selecting a context in which the balance group is to operation is selected after selecting the one or more balance types and time periods;
determining sort options are needed to support a functionality to be provided by the balance group;
selecting a format type for the balance group, wherein the format type indicates the format in which defined balance information is organized when returned to a payroll application.

6. The computer readable memory of claim 5 wherein the format type comprises a matrix table.

7. The computer readable memory of claim 5 wherein the format type comprises a single table.

8. The computer readable memory of claim 5 wherein the method further comprises:
reviewing the balance group to ensure that information will be returned;
after reviewing the balance group to ensure that information will be returned, saving the balance group to a metadata repository.

9. A payroll application architecture comprising:
a metadata layer, wherein
the metadata layer comprises
a metadata service, and
the metadata service is configured to provide access to a balance group definition; and
a data layer, wherein
the data layer comprises
a metadata repository,
the metadata service and the metadata repository are communicatively coupled to one another, and
the metadata repository is configured to
store the balance group definition, and
provide the balance group definition to the metadata service.

10. The payroll application architecture of claim 9, further comprising:
a payroll application, wherein
the payroll application and the metadata service are communicatively coupled to one another.

11. The payroll application architecture of claim 10, wherein the payroll application comprises:
a report generation module, wherein
the report generation module and the metadata service are communicatively coupled to one another,
the report generation module is configured to facilitate a reporting functionality of the payroll application, and
the report generation module is configured to facilitate the reporting functionality of the payroll application using the balance group definition.

12. The payroll application architecture of claim 11, further comprising:
a payroll processing user interface, wherein
the payroll processing user interface and the report generation module are communicatively coupled to one another, and
the payroll processing user interface is configured to control the reporting functionality of the payroll application.

13. The payroll application architecture of claim 12, wherein
the report generation module is configured to facilitate the reporting functionality of the payroll application by virtue of being configured to generate a report,
the report generation module is configured to generate the report using the balance group definition, and
the payroll processing user interface is further configured to present the report in a payroll report user interface screen.

14. The payroll application architecture of claim 10, wherein the payroll application comprises:
a payroll management module, wherein
the payroll management module and the metadata service are communicatively coupled to one another,
the payroll management module is configured to facilitate a maintenance functionality of the payroll application, and
the payroll management module is configured to facilitate the maintenance functionality of the payroll application by virtue of being configured to manage the balance group definition.

15. The payroll application architecture of claim 14, further comprising:
a payroll management user interface, wherein
the payroll management user interface and the payroll management module are communicatively coupled to one another, and
the payroll management generation module is configured to control the maintenance functionality of the payroll application.

16. The payroll application architecture of claim 15, wherein
the payroll management module is configured to facilitate the maintenance functionality of the payroll application by virtue of being configured to perform maintenance of payroll information stored in the metadata repository,
the payroll information comprises the balance group definition, and
the payroll management user interface is further configured to facilitate the control of the maintenance functionality of the payroll application via a balance group views screen.

17. The payroll application architecture of claim 10, wherein the payroll application comprises:
a report generation module, wherein
the report generation module and the metadata service are communicatively coupled to one another,
the report generation module is configured to facilitate a reporting functionality of the payroll application, and
the report generation module is configured to facilitate the reporting functionality of the payroll application using the balance group definition; and
a payroll management module, wherein
the payroll management module and the metadata service are communicatively coupled to one another,
the payroll management module is configured to facilitate a maintenance functionality of the payroll application, and
the payroll management module is configured to facilitate the maintenance functionality of the payroll application by virtue of being configured to manage the balance group definition.

18. The payroll application architecture of claim 17, wherein the payroll application comprises:
a payroll processing user interface, wherein
the payroll processing user interface and the report generation module are communicatively coupled to one another,
the payroll processing user interface comprises a payroll report user interface screen,
the payroll report user interface screen is configured to present defined balance data generated by the report generation module using the balance group definition, and
the payroll processing user interface is configured to control the report generation module to facilitate the presenting of the defined balance data; and
a payroll management user interface, wherein
the payroll management user interface and the payroll management module are communicatively coupled to one another,
the payroll management user interface comprises a balance group view screen,
the balance group view screen is configured to facilitate maintenance of the balance group definition, and
the payroll management user interface is configured to control the payroll management module to facilitate the maintenance.

19. The payroll application architecture of claim 9, further comprising:
a balance data store, wherein
the metadata layer is configured to access the balance data store using the balance group definition.

20. The payroll application architecture of claim 19, further comprising:
a payroll application, wherein
the metadata layer is further configured to format data retrieved from the balance data store using the balance group definition, in a table format, and
the table format facilitates processing of the data by the payroll application.
